(19) United States
(12) Patent Application Publication
(10) Pub. No.: US 2025/0008453 A1
(43) Pub. Date: Jan. 2, 2025

(54) METHOD AND APPARATUS FOR HANDLING TIMING ADVANCE FOR CELLS IN A WIRELESS COMMUNICATION SYSTEM

(71) Applicant: ASUS Technology Licensing Inc., Taipei City (TW)

(72) Inventors: Yi-Hsuan Kung, Taipei City (TW); Yu-Hsuan Guo, Taipei City (TW)

(21) Appl. No.: 18/755,326

(22) Filed: Jun. 26, 2024

Related U.S. Application Data
(60) Provisional application No. 63/524,548, filed on Jun. 30, 2023.
(60) Provisional application No. 63/524,566, filed on Jun. 30, 2023.

(51) Int. Cl. H04W 56/00; H04W 48/16; H04W 76/27

(52) U.S. Cl. CPC H04W 56/001; H04W 48/16

(57) ABSTRACT

Methods, systems, and apparatuses are provided for handling timing advance for cells in a wireless communication system, comprising a User Equipment (UE) receiving a configuration indicating at least one candidate cell including a first candidate cell, storing a first Timing Advance (TA) associated with the first candidate cell, and clearing or discarding the first TA associated with the first candidate cell in response to at least one of: expiry of a timer associated with the first TA; performing Radio Resource Control (RRC) re-establishment; the UE entering RRC_IDLE state or RRC_INACTIVE state; a serving cell change; and/or the UE storing a second TA when a list or a set of stored TAs for the at least one candidate cell is full.

### CROSS-REFERENCE TO RELATED APPLICATIONS

The present application claims priority to and the benefit of U.S. Provisional Patent Application Ser. No. 63/524,548, filed Jun. 30, 2023, and U.S. Provisional Patent Application Ser. No. 63/524,566, filed Jun. 30, 2023; with each of the referenced applications and disclosures fully incorporated herein by reference.

### FIELD

This disclosure generally relates to wireless communication networks and, more particularly, to a method and apparatus for handling timing advance for cells in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for handling timing advance for cells in a wireless communication system by obtaining and storing Timing Advance (TA) for candidate cells before L1/L2 Triggered Mobility (LTM).

In various embodiments, a method of a User Equipment (UE) in a wireless communication system comprises receiving a configuration indicating at least one candidate cell including a first candidate cell, storing a first TA associated with the first candidate cell, and clearing or discarding the first TA associated with the first candidate cell in response to at least one of: expiry of a timer associated with the first TA; performing Radio Resource Control (RRC) re-establishment; the UE entering RRC_IDLE state or RRC_INACTIVE state; a serving cell change; and/or the UE storing a second TA when a list or a set of stored TAs for the at least one candidate cell is full.

In various embodiments, a method of a UE in a wireless communication system comprises receiving a configuration indicating at least one candidate cell including a first candidate cell, storing a first TA associated with the first candidate cell, and transmitting a report to a network, wherein the report indicates information related to the first TA.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 6.1.3.4-1: Timing Advance Command MAC CE, from 3GPP 38.321.v17.2.0.

FIG. 6 is a reproduction of FIG. 6.1.3.4a-1: Absolute Timing Advance Command MAC CE, from 3GPP 38.321 v17.2.0.

FIG. 7 is a reproduction of FIG. 5.3.7.1-1: RRC connection re-establishment, successful, from 3GPP 38.331 v17.2.0.

FIG. 8 is a reproduction of FIG. 5.3.7.1-2: RRC re-establishment, fallback to RRC establishment, successful, from 3GPP 38.331 v17.2.0.

FIG. 9 is a reproduction of FIG. 5.4.3.1-1: Mobility from NR, successful, from 3GPP 38.331 v17.2.0.

FIG. 10 is a reproduction of FIG. 5.4.3.1-2: Mobility from NR, failure, from 3GPP 38.331 v17.2.0

FIG. 11 is a reproduction of Figure x, signaling procedure for LTM, from R2-2213332 38.300 running CR for introduction of NR further mobility enhancements.

FIG. 12 is a reproduction of FIG. 4.3.1-1: Uplink-downlink timing relation, from 3GPP 38.211 v17.1.0.

FIG. 13 is an example diagram of a UE storing/maintaining a maximum number of stored TAs, in accordance with embodiments of the present invention.

FIG. 14 is an example diagram of a UE storing a maximum of 3 TAs, TA1, TA2, and TA3 for candidate cells 1, 2, and 3, respectively, in accordance with embodiments of the present invention.

FIG. 15 is an example diagram of a UE storing TA1 and TA2 for candidate cell 1 and candidate cell 2 before timing t1, in accordance with embodiments of the present invention.

FIG. 16 is an example diagram of a UE storing TA1 and TA2 for candidate cells 1 and 2, wherein at timing t1 the TA2 becomes invalid, in accordance with embodiments of the present invention.

FIG. 17 is an example diagram wherein, at timing t0, a UE reports to a NW a TA report indicating that the UE stores TA (TA1, TA2) for candidate cell 1, in accordance with embodiments of the present invention.

FIG. 18 is an example diagram of a report indicating one or more candidate configuration IDs associated with one or more candidate cells, in accordance with embodiments of the present invention.

FIG. 18A is an example diagram of a report indicating a field/flag indicating whether the report indicates the UE adds or clears stored Tas for the indicated configurations/associated candidate cells, in accordance with embodiments of the present invention.

FIG. 18B is an example diagram of a report indicating whether the report includes a TA value for each candidate cell reported, in accordance with embodiments of the present invention.

FIG. 19 is a flow diagram of method of a UE in a wireless communication system comprising storing or maintaining a TA for a candidate cell and clearing the TA of the candidate cell in response to at least one of a list of potential events, in accordance with embodiments of the present invention.

FIG. 20 is a flow diagram of a method of a UE in a wireless communication system comprising transmitting a report to a network, wherein the report contains or indicates TA storage status of one or more candidate cells, in accordance with embodiments of the present invention.

FIG. 21 is a flow diagram of a method of a UE in a wireless communication system comprising receiving a configuration indicating at least one candidate cell including a first candidate cell, storing a first TA associated with the first candidate cell, and clearing or discarding the first TA associated with the first candidate cell in response to at least one of a list of potential events, in accordance with embodiments of the present invention.

FIG. 22 is a flow diagram of a method of a UE in a wireless communication system comprising receiving a configuration indicating at least one candidate cell including a first candidate cell, storing a first TA associated with the first candidate cell, and transmitting a report to a network, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project,” referred to herein as 3GPP, including: [1] 3GPP 38.321 v17.2.0; [2] 3GPP 38.331 v17.2.0; [3] RP-212710 New WID on NR further mobility enhancements; [4] R2-2213332 38.300 running CR for introduction of NR further mobility enhancements; [5] 3GPP RAN1 #110b report; [6] 3GPP RAN1 #112 report; [7] 3GPP RAN2 #121bis report; [8] 3GPP RAN2 #122 report; and [9] 3GPP 38.211 v17.1.0. The standards and documents listed above are hereby expressly and fully incorporated herein by reference in their entirety.

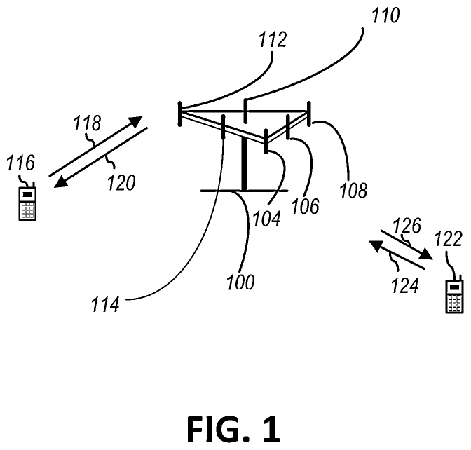

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

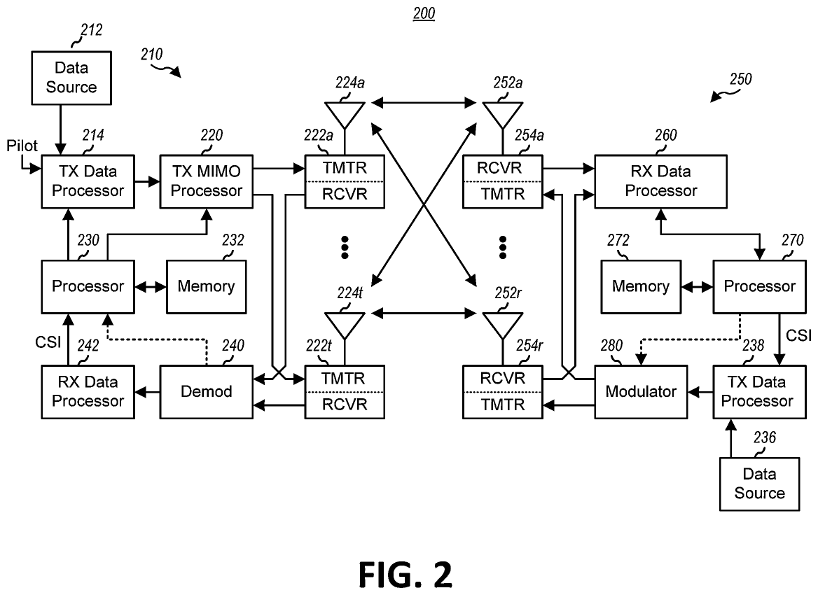

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

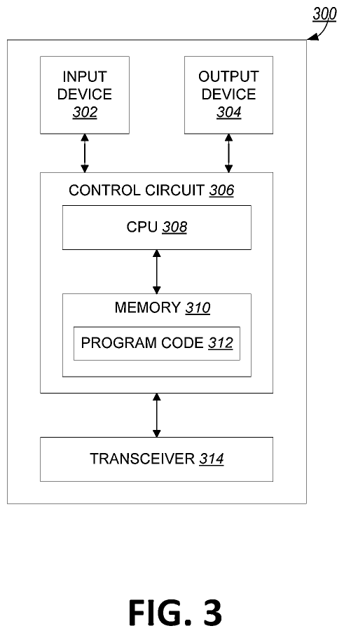

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the N_{R} system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

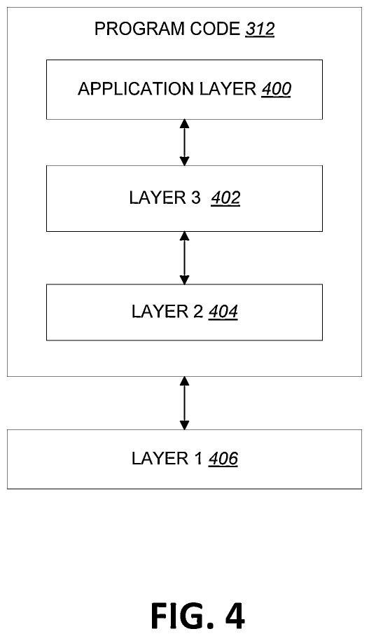

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or N_{R} systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In 38.321 (e.g., [1] 3GPP 38.321 v17.2.0), random access procedure, TA maintenance, and random access procedures are introduced:

### 5.2 Maintenance of Uplink Time Alignment

RRC configures the following parameters for the maintenance of UL time alignment:
timeAlignmentTimer (per TAG) which controls how long the MAC entity considers the Serving Cells belonging to the associated TAG to be uplink time aligned;
inactivePosSRS-TimeAlignmentTimer which controls how long the MAC entity considers the Positioning SRS transmission in RRC_INACTIVE in clause 5.26 to be uplink time aligned;
cg-SDT-TimeAlignmentTimer which controls how long the MAC entity considers the uplink transmission for CG-SDT to be uplink time aligned.

The MAC entity shall:
1> when a Timing Advance Command MAC CE is received, and if an N_{TA} (as defined in TS 38.211 [8]) has been maintained with the indicated TAG:
   2> apply the Timing Advance Command for the indicated TAG;
   2> if inactivePosSRS-TimeAlignmentTimer is configured and there is ongoing Positioning SRS Transmission in RRC_INACTIVE as in clause 5.26:
      3> start or restart the inactivePosSRS-TimeAlignmentTimer associated with the indicated TAG.
   2> if CG-SDT procedure triggered as in clause 5.27 is ongoing:
      3> start or restart the cg-SDT-TimeAlignmentTimer associated with the indicated TAG.
   2> else:
      3> start or restart the timeAlignmentTimer associated with the indicated TAG.
1> when a Timing Advance Command is received in a Random Access Response message for a Serving Cell belonging to a TAG or in a MSGB for an SpCell:
   2> if the Random Access Preamble was not selected by the MAC entity among the contention-based Random Access Preamble:
      3> apply the Timing Advance Command for this TAG;
      3> start or restart the timeAlignmentTimer associated with this TAG.
   2> else if the timeAlignmentTimer associated with this TAG is not running:
      3> apply the Timing Advance Command for this TAG;
      3> start the timeAlignmentTimer associated with this TAG;
      3> when the Contention Resolution is considered not successful as described in clause 5.1.5; or
      3> when the Contention Resolution is considered successful for SI request as described in clause 5.1.5, after transmitting HARQ feedback for MAC PDU including UE Contention Resolution Identity MAC CE:
         4> stop timeAlignmentTimer associated with this TAG.
      3> when the Contention Resolution is considered not successful as described in clause 5.1.5:
         4> if CG-SDT procedure triggered as in clause 5.27 is ongoing:
         5> set the N_{TA} value to the value before applying the received Timing Advance Command as in TS 38.211 [8].
      3> when the Contention Resolution is considered successful for Random Access procedure while the CG-SDT procedure is ongoing:
         4> stop timeAlignmentTimer associated with this TAG;
         4> start or restart the cg-SDT-TimeAlignmentTimer associated with this TAG.
      3> when the Contention Resolution is considered successful for Random Access procedure while SRS transmission in RRC_INACTIVE is ongoing:
         4> start or restart the inactive PosSRS-TimeAlignmentTimer associated with this TAG.
   2> else:
      3> ignore the received Timing Advance Command.
1> when an Absolute Timing Advance Command is received in response to a MSGA transmission including C-RNTI MAC CE as specified in clause 5.1.4a:
   2> apply the Timing Advance Command for PTAG;
   2> if CG-SDT procedure is ongoing:
      3> start or restart the cg-SDT-TimeAlignmentTimer associated with PTAG.
   2> else:
      3> start or restart the timeAlignmentTimer associated with PTAG.
1> when the indication is received from upper layer for stopping the inactivePosSRS-TimeAlignmentTimer.
   2> stop the inactivePosSRS-TimeAlignmentTimer.
1> when the indication is received from upper layer for starting the inactivePosSRS-TimeAlignmentTimer.
   2> start or restart the inactivePosSRS-TimeAlignmentTimer.
1> when instruction from the upper layer has been received for starting the cg-SDT-TimeAlignmentTimer.
   2> start the cg-SDT-TimeAlignmentTimer.
1> when instruction from the upper layer has been received for stopping the cg-SDT-TimeAlignmentTimer.
   2> consider the cg-SDT-TimeAlignmentTimer as expired.
1> when instruction from the upper layer has been received for starting the TimeAlignmentTimer associated with PTAG:
   2> start the TimeAlignmentTimer associated with PTAG.
1> when a timeAlignmentTimer expires:
   2> if the timeAlignmentTimer is associated with the PTAG:
      3> flush all HARQ buffers for all Serving Cells;
      3> notify RRC to release PUCCH for all Serving Cells, if configured;
      3> notify RRC to release SRS for all Serving Cells, if configured;
      3> clear any configured downlink assignments and configured uplink grants;
      3> clear any PUSCH resource for semi-persistent CSI reporting;
      3> consider all running timeAlignmentTimers as expired;
      3> maintain N_{TA} (defined in TS 38.211 [8]) of all TAGs.
   2> else if the timeAlignmentTimer is associated with an STAG, then for all Serving Cells belonging to this TAG:
      3> flush all HARQ buffers;
      3> notify RRC to release PUCCH, if configured;
      3> notify RRC to release SRS, if configured;
      3> clear any configured downlink assignments and configured uplink grants;
      3> clear any PUSCH resource for semi-persistent CSI reporting;
      3> maintain N_{TA} (defined in TS 38.211 [8]) of this TAG.
1> when the inactivePosSRS-TimeAlignmentTimer expires:
   2> notify RRC to release Positioning SRS for RRC_INACTIVE configuration(s).
1> when the cg-SDT-TimeAlignmentTimer expires:
   2> clear any configured uplink grants;
   2> if a PDCCH addressed to the MAC entity's C-RNTI after initial transmission for the CG-SDT with CCCH message has not been received:
      3> consider ongoing CG-SDT procedure as terminated;
      3> indicate the expiry of cg-SDT-TimeAlignmentTimer to the upper layer.
   2> flush all HARQ buffers;
   2> maintain N_{TA} (defined in TS 38.211 [8]) of this TAG.

When the MAC entity stops uplink transmissions for an SCell due to the fact that the maximum uplink transmission timing difference between TAGs of the MAC entity or the maximum uplink transmission timing difference between TAGs of any MAC entity of the UE is exceeded, the MAC entity considers the timeAlignmentTimer associated with the SCell as expired.

The MAC entity shall not perform any uplink transmission on a Serving Cell except the Random Access Preamble and MSGA transmission when the timeAlignmentTimer associated with the TAG to which this Serving Cell belongs is not running, CG-SDT procedure is not ongoing or SRS transmission in RRC_INACTIVE as in clause 5.26 is not on-going. Furthermore, when the timeAlignmentTimer associated with the PTAG is not running, CG-SDT procedure is not ongoing and SRS transmission in RRC_INACTIVE as in clause 5.26 is not ongoing, the MAC entity shall not perform any uplink transmission on any Serving Cell except the Random Access Preamble and MSGA transmission on the SpCell. The MAC entity shall not perform any uplink transmission except the Random Access Preamble and MSGA transmission when the cg-SDT-TimeAlignmentTimer is not running during the ongoing CG-SDT procedure as triggered in clause 5.27. The MAC entity shall not perform any uplink transmission except the Random Access Preamble and MSGA transmission when inactive PosSRS-TimeAlignmentTimer is not running during the procedure for SRS transmission in RRC_INACTIVE as in clause 5.26.

### 6.1.3.4 Timing Advance Command MAC CE

The Timing Advance Command MAC CE is identified by MAC subheader with LCID as specified in Table 6.2.1-1.

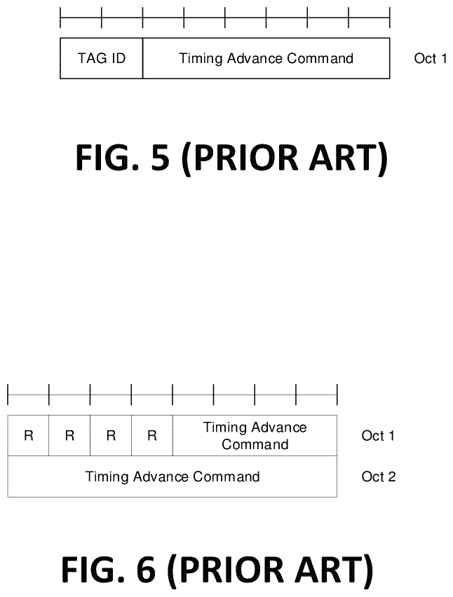

It has a fixed size and consists of a single octet defined as follows (FIG. 6.1.3.4-1):
TAG Identity (TAG ID): This field indicates the TAG Identity of the addressed TAG. The TAG containing the SpCell has the TAG Identity 0. The length of the field is 2 bits;
Timing Advance Command: This field indicates the index value TA (0, 1, 2 . . . 63) used to control the amount of timing adjustment that MAC entity has to apply (as specified in TS 38.213 [6]). The length of the field is 6 bits.
   FIG. 5 is a reproduction of FIG. 6.1.3.4-1: Timing Advance Command MAC CE, from 3GPP 38.321. v17.2.0.

### 6.1.3.4a Absolute Timing Advance Command MAC CE

The Absolute Timing Advance Command MAC CE is identified by MAC subheader with eLCID as specified in Table 6.2.1-1b.

It has a fixed size and consists of two octets defined as follows (FIG. 6.1.3.4a-1):
Timing Advance Command: This field indicates the index value TA used to control the amount of timing adjustment that the MAC entity has to apply in TS 38.213 [6]. The size of the field is 12 bits;
R: Reserved bit, set to 0.
   FIG. 6 is a reproduction of FIG. 6.1.3.4a-1: Absolute Timing Advance Command MAC CE, from 3GPP 38.321 v17.2.0.

### 3.1 Definitions

Primary Cell: The MCG cell, operating on the primary frequency, in which the UE either performs the initial connection establishment procedure or initiates the connection re-establishment procedure.

Primary SCG Cell: For dual connectivity operation, the SCG cell in which the UE performs random access when performing the Reconfiguration with Sync procedure.

Secondary Cell: For a UE configured with CA, a cell providing additional radio resources on top of Special Cell.

Secondary Cell Group: For a UE configured with dual connectivity, the subset of serving cells comprising of the PSCell and zero or more secondary cells.

Serving Cell: For a UE in RRC_CONNECTED not configured with CA/DC there is only one serving cell comprising of the primary cell. For a UE in RRC_CONNECTED configured with CA/DC the term ‘serving cells’ is used to denote the set of cells comprising of the Special Cell(s) and all secondary cells.

Special Cell: For Dual Connectivity operation the term Special Cell refers to the PCell of the MCG or the PSCell of the SCG, otherwise the term Special Cell refers to the PCell.

Timing Advance Group: A group of Serving Cells that is configured by RRC and that, for the cells with a UL configured, using the same timing reference cell and the same Timing Advance value. A Timing Advance Group containing the SpCell of a MAC entity is referred to as Primary Timing Advance Group (PTAG), whereas the term Secondary Timing Advance Group (STAG) refers to other TAGs.
In 38.331 (e.g., [2] 3GPP 38.331 v17.2.0), RRC reconfiguration, Cell group and Serving Cell configuration is introduced, including TAG configuration:

### 4.2.1 UE States and State Transitions Including Inter RAT

A UE is either in RRC_CONNECTED state or in RRC_INACTIVE state when an RRC connection has been established. If this is not the case, i.e. no RRC connection is established, the UE is in RRC_IDLE state. The RRC states can further be characterised as follows:

. . .

### 5.3.5.5 Cell Group Configuration

### 5.3.5.5.1 General

The network configures the UE with Master Cell Group (MCG), and zero or one Secondary Cell Group (SCG). In (NG) EN-DC, the MCG is configured as specified in TS 36.331 [10], and for NE-DC, the SCG is configured as specified in TS 36.331 [10]. The network provides the configuration parameters for a cell group in the CellGroupConfig IE.

The UE performs the following actions based on a received CellGroupConfig IE:
1> if the CellGroupConfig contains the spCellConfig with reconfiguration WithSync:
   2> perform Reconfiguration with sync according to 5.3.5.5.2;
   2> resume all suspended radio bearers except the SRBs for the source cell group, and resume SCG transmission for all radio bearers, and resume BH RLC channels and resume SCG transmission for BH RLC channels for IAB-MT, if suspended;
1> if the CellGroupConfig contains the rlc-BearerToReleaseList:
   2> perform RLC bearer release as specified in 5.3.5.5.3;
1> if the CellGroupConfig contains the rlc-BearerToAddModList:
   2> perform the RLC bearer addition/modification as specified in 5.3.5.5.4;
1> if the CellGroupConfig contains the mac-CellGroupConfig:
   2> configure the MAC entity of this cell group as specified in 5.3.5.5.5;
1> if the CellGroupConfig contains the sCellToReleaseList:
   2> perform SCell release as specified in 5.3.5.5.8;
1> if the CellGroupConfig contains the spCellConfig:
   2> configure the SpCell as specified in 5.3.5.5.7;
1> if the CellGroupConfig contains the sCellToAddModList:
   2> perform SCell addition/modification as specified in 5.3.5.5.9;
1> if the CellGroupConfig contains the bh-RLC-ChannelToReleaseList:
   2> perform BH RLC channel release as specified in 5.3.5.5.10;
1> if the CellGroupConfig contains the bh-RLC-ChannelToAddModList:
   2> perform the BH RLC channel addition/modification as specified in 5.3.5.5.11;
      5.3.5.5.2 Reconfiguration with Sync

The UE shall perform the following actions to execute a reconfiguration with sync.
1> if the AS security is not activated, perform the actions upon going to RRC_IDLE as specified in 5.3.11 with the release cause ‘other’ upon which the procedure ends;
1> if no DAPS bearer is configured:
   2> stop timer T310 for the corresponding SpCell, if running;
1> if this procedure is executed for the MCG:
   2> if timer T316 is running;
      3> stop timer T316;
      3> clear the information included in VarRLF-Report, if any;
   2> resume MCG transmission, if suspended.
1> stop timer T312 for the corresponding SpCell, if running;
1> start timer T304 for the corresponding SpCell with the timer value set to t304, as included in the reconfiguration WithSync;
1> if the frequencyInfoDL is included:
   2> consider the target SpCell to be one on the SSB frequency indicated by the frequencyInfoDL with a physical cell identity indicated by the physCellId;
1> else:
   2> consider the target SpCell to be one on the SSB frequency of the source SpCell with a physical cell identity indicated by the physCellId;
1> start synchronising to the DL of the target SpCell;
1> apply the specified BCCH configuration defined in 9.1.1.1 for the target SpCell;
1> acquire the MIB of the target SpCell, which is scheduled as specified in TS 38.213 [13];
NOTE 1: The UE should perform the reconfiguration with sync as soon as possible following the reception of the RRC message triggering the reconfiguration with sync, which could be before confirming successful reception (HARQ and ARQ) of this message.
NOTE 2: The UE may omit reading the MIB if the UE already has the required timing information, or the timing information is not needed for random access.
NOTE 2a: A UE with DAPS bearer does not monitor for system information updates in the source PCell.
1> If any DAPS bearer is configured:
   2> create a MAC entity for the target cell group with the same configuration as the MAC entity for the source cell group;
   2> for each DAPS bearer:
      3> establish an RLC entity or entities for the target cell group, with the same configurations as for the source cell group;
      3> establish the logical channel for the target cell group, with the same configurations as for the source cell group;
NOTE 2b: In order to understand if a DAPS bearer is configured, the UE needs to check the presence of the field daps-Config within the RadioBearerConfig IE received in radioBearerConfig or radioBearerConfig2.
   2> for each SRB:
      3> establish an RLC entity for the target cell group, with the same configurations as for the source cell group;
      3> establish the logical channel for the target cell group, with the same configurations as for the source cell group;
   2> suspend SRBs for the source cell group;
NOTE 3: Void
   2> apply the value of the newUE-Identity as the C-RNTI in the target cell group;
   2> configure lower layers for the target SpCell in accordance with the received spCellConfigCommon;
   2> configure lower layers for the target SpCell in accordance with any additional fields, not covered in the previous, if included in the received reconfiguration WithSync.
1> else:
   2> reset the MAC entity of this cell group;
   2> consider the SCell(s) of this cell group, if configured, that are not included in the SCellToAddModList in the RRCReconfiguration message, to be in deactivated state;
   2> apply the value of the newUE-Identity as the C-RNTI for this cell group;
   2> configure lower layers in accordance with the received spCellConfigCommon;
   2> configure lower layers in accordance with any additional fields, not covered in the previous, if included in the received reconfiguration WithSync.

### 5.3.5.5.8 SCell Release

The UE shall:
1> if the release is triggered by reception of the sCellToRelease List:
   2> for each sCellIndex value included in the sCellToReleaseList:
      3> if the current UE configuration includes an SCell with value sCellIndex:
         4> release the SCell.

### 5.3.5.5.9 SCell Addition/Modification

The UE shall:
1> for each sCellIndex value included in the sCellToAddModList that is not part of the current UE configuration (SCell addition):
   2> add the SCell, corresponding to the sCellIndex, in accordance with the sCellConfigCommon and sCellConfigDedicated;
   2> if the sCellState is included:
      3> configure lower layers to consider the SCell to be in activated state;
   2> else:
      3> configure lower layers to consider the SCell to be in deactivated state;
   2> for each measId included in the measIdList within VarMeasConfig:
      3> if SCells are not applicable for the associated measurement; and
      3> if the concerned SCell is included in cellsTriggeredList defined within the VarMeasReportList for this measId:
         4> remove the concerned SCell from cellsTriggeredList defined within the VarMeasReportList for this measId;
1> for each sCellIndex value included in the sCellToAddModList that is part of the current UE configuration (SCell modification):
   2> modify the SCell configuration in accordance with the sCellConfigDedicated;
   2> if the sCellToAddModList was received in an RRCReconfiguration message including reconfiguration WithSync, or received in an RRCResume message, or received in an RRCReconfiguration message including reconfiguration WithSync embedded in an RRCResume message or embedded in an RRCReconfiguration message or embedded in an E-UTRA RRCConnectionReconfiguration message or embedded in an E-UTRA RRCConnectionResume message:
      3> if the sCellState is included:
         4> configure lower layers to consider the SCell to be in activated state;
      3> else:
         4> configure lower layers to consider the SCell to be in deactivated state.

### 5.3.7 RRC Connection Re-Establishment

### 5.3.7.1 General

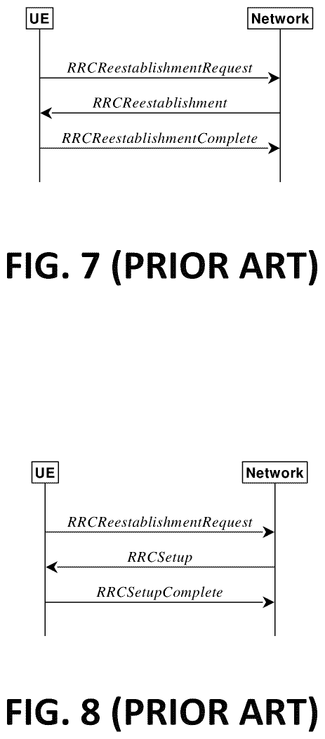

FIG. 7 is a reproduction of FIG. 5.3.7.1-1: RRC connection re-establishment, successful, from 3GPP 38.331 v17.2.0.
FIG. 8 is a reproduction of FIG. 5.3.7.1-2: RRC re-establishment, fallback to RRC establishment, successful, from 3GPP 38.331 v17.2.0.

The purpose of this procedure is to re-establish the RRC connection. A UE in RRC_CONNECTED, for which AS security has been activated with SRB2 and at least one DRB/multicast MRB setup or, for IAB, SRB2, may initiate the procedure in order to continue the RRC connection. The connection re-establishment succeeds if the network is able to find and verify a valid UE context or, if the UE context cannot be retrieved, and the network responds with an RRCSetup according to clause 5.3.3.4.

. . .

### 5.3.5.13 Conditional Reconfiguration

### 5.3.5.13.1 General

The network configures the UE with one or more candidate target SpCells in the conditional reconfiguration. The UE evaluates the condition of each configured candidate target SpCell. The UE applies the conditional reconfiguration associated with one of the target SpCells which fulfils associated execution condition. The network provides the configuration parameters for the target SpCell in the ConditionalReconfiguration IE.

. . .

5.4.3 Mobility from NR

### 5.4.3.1 General

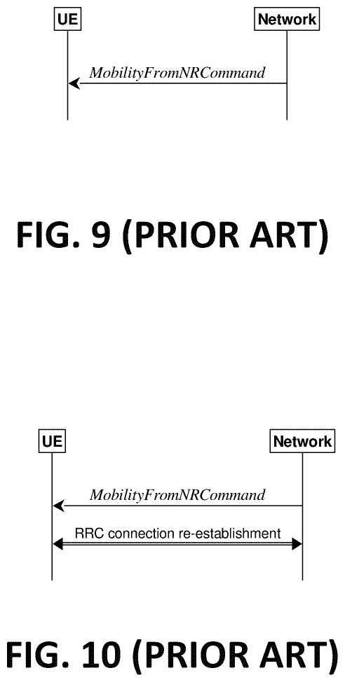

FIG. 9 is a reproduction of FIG. 5.4.3.1-1: Mobility from NR, successful, from 3 GPP 38.331 v17.2.0.
FIG. 10 is a reproduction of FIG. 5.4.3.1-2: Mobility from NR, failure, from 3GPP 38.331 v17.2.0.

The purpose of this procedure is to move a UE in RRC_CONNECTED to a cell using other RAT, e.g. E-UTRA, UTRA-FDD. The mobility from N_{R} procedure covers the following type of mobility:
handover, i.e. the MobilityFromNRCommand message includes radio resources that have been allocated for the UE in the target cell;

### CellGroupConfig

The CellGroupConfig IE is used to configure a master cell group (MCG) or secondary cell group (SCG). A cell group comprises of one MAC entity, a set of logical channels with associated RLC entities and of a primary cell (SpCell) and one or more secondary cells (SCells).

### CellGroupConfig Information Element

| | |
|---|---|
| -- ASN1START | |
| -- TAG-CELLGROUPCONFIG-START | |
| -- Configuration of one Cell-Group: | |
| CellGroupConfig ::= | SEQUENCE { |
| cellGroupId | CellGroupId, |
| rlc-BearerToAddModList | SEQUENCE (SIZE (1..maxLC-ID)) OF RLC-BearerConfig |
| OPTIONAL, -- Need N | |
| rlc-BearerToReleaseList | SEQUENCE (SIZE (1..maxLC-ID)) OF LogicalChannelIdentity |
| OPTIONAL, -- Need N | |
| mac-CellGroupConfig | MAC-CellGroupConfig |
| OPTIONAL, -- Need M | |
| physicalCellGroupConfig | PhysicalCellGroupConfig |
| OPTIONAL, -- Need M | |
| spCellConfig | SpCellConfig |
| OPTIONAL, -- Need M | |
| sCellToAddModList | SEQUENCE (SIZE (1..maxNrofSCells)) OF SCellConfig |
| OPTIONAL, -- Need N | |
| sCellToReleaseList | SEQUENCE (SIZE (1..maxNrofSCells)) OF SCellIndex |
| OPTIONAL, -- Need N | |
| ..., | |
| [[ | |
| reportUplinkTxDirectCurrent | ENUMERATED {true} |
| OPTIONAL -- Cond BWP-Reconfig | |
| ]], | |
| [[ | |
| bap-Address-r16 | BIT STRING (SIZE (10)) |
| OPTIONAL, -- Need M | |
| bh-RLC-ChannelToAddModList-r16 | SEQUENCE (SIZE (1..maxBH-RLC-ChannelID-r16)) OF BH-RLC- |
| ChannelConfig-r16 OPTIONAL, -- Need N | |
| bh-RLC-ChannelToReleaseList-r16 | SEQUENCE (SIZE (1..maxBH-RLC-ChannelID-r16)) OF BH-RLC- |
| ChannelID-r16 OPTIONAL, -- Need N | |
| flc-TransferPath-r16 | ENUMERATED {lte, nr, both} |
| OPTIONAL, -- Need M | |
| simultaneousTCI-UpdateList1-r16 | SEQUENCE (SIZE (1..maxNrofServingCellsTCI-r16)) OF |
| ServCellIndex OPTIONAL, -- Need R | |
| simultaneousTCI-UpdateList2-r16 | SEQUENCE (SIZE (1..maxNrofServingCellsTCI-r16)) OF |
| ServCellIndex OPTIONAL, -- Need R | |
| simultaneousSpatial-UpdatedList1-r16 | SEQUENCE (SIZE (1..maxNrofServingCellsTCI-r16)) OF |
| ServCellIndex OPTIONAL, -- Need R | |
| simultaneousSpatial-UpdatedList2-r16 | SEQUENCE (SIZE (1..maxNrofServingCellsTCI-r16)) OF |
| ServCellIndex OPTIONAL, -- Need R | |
| uplinkTxSwitchingOption-r16 | ENUMERATED {switchedUL, dualUL} |
| OPTIONAL, -- Need R | |
| uplinkTxSwitchingPowerBoosting-r16 | ENUMERATED {enabled} |
| OPTIONAL -- Need R | |
| ]], | |
| [[ | |
| reportUplinkTxDirectCurrentTwoCarrier-r16 | ENUMERATED {true} |
| OPTIONAL -- Need N | |
| ]] | |
| } | |

-- Serving cell specific MAC and PHY parameters for a SpCell:

| | |
|---|---|
| SpCellConfig ::= | SEQUENCE { |
| servCellIndex | ServCellIndex |
| OPTIONAL, -- Cond SCG | |
| reconfigurationWithSync | ReconfigurationWithSync |
| OPTIONAL, -- Cond ReconfWithSync | |
| rlf-TimersAndConstants | SetupRelease { RLF-TimersAndConstants } |
| OPTIONAL, -- Need M | |
| rlmInSyncOutOfSyncThreshold | ENUMERATED {n1} |
| OPTIONAL -- Need S | |
| spCellConfigDedicated | ServingCellConfig |
| OPTIONAL, -- Need M | |
| ... | |
| } | |
| ReconfigurationWithSync ::= | SEQUENCE { |
| spCellConfigCommon | ServingCellConfigCommon |
| OPTIONAL, -- Need M | |
| newUE-Identity | RNTI-Value, |
| t304 | ENUMERATED {ms50, ms100, ms150, ms200, ms500, ms1000, ms2000, |
| ms10000}, | |
| rach-ConfigDedicated | CHOICE { |
| uplink | RACH-ConfigDedicated, |
| supplementaryUplink | RACH-ConfigDedicated |
| } | |
| OPTIONAL, -- Need N | |
| ..., | |
| [[ | |
| smtc | SSB-MTC |
| OPTIONAL, -- Need S | |
| ]], | |
| [[ | |
| daps-UplinkPowerConfig-r16 | DAPS-UplinkPowerConfig-r16 |
| OPTIONAL, -- Need N | |
| ]] | |
| } | |
| DAPS-UplinkPowerConfig-r16 | SEQUENCE { |
| p-DAPS-Source-r16 | P-Max, |
| p-DAPS-Target-r16 | P-Max, |
| uplinkPower SharingDAPS-Mode-r16 | ENUMERATED {semi-static-model, semi-static-mode2, dynamic } |
| } | |
| SCellConfig ::= | SEQUENCE { |
| sCellIndex | SCellIndex, |
| sCellConfigCommon | ServingCellConfigCommon |
| OPTIONAL, -- Cond SCellAdd | |
| sCellConfigDedicated | ServingCellConfig |
| OPTIONAL, -- Cond SCellAddMod | |
| ..., | |
| [[ | |
| smtc | SSB-MTC |
| OPTIONAL -- Need S | |
| ]], | |
| [[ | |
| sCellState-r16 | ENUMERATED {activated} |
| OPTIONAL, -- Cond SCellAddSync | |
| secondaryDRX-GroupConfig-r16 | ENUMERATED {true} |
| OPTIONAL -- Cond DRX-Config2 | |
| ]]} | |
| -- TAG-CELLGROUPCONFIG-STOP | |
| -- ASN1STOP | |

In introduction of PeMIMO for RRC specification (e.g., [6] 3GPP RAN1 #112 report), measurement object and serving cell configuration for additional Cell(s) are introduced:

### ServingCellConfig

The LE ServingCellConfig is used to configure (add or modify) the UE with a serving cell, which may be the SpCell or an SCell of an MCG or SCG. The parameters herein are mostly UE specific but partly also cell specific (e.g. in additionally configured bandwidth parts). Reconfiguration between a PUCCH and PUCCHless SCell is only supported using an SCell release and add.

### ServingCellConfig Information Element

| | |
|---|---|
| -- ASN1START | |
| -- TAG-SERVINGCELLCONFIG-STOP | |
| ServingCellConfig ::= | SEQUENCE { |
| tdd-UL-DL-ConfigurationDedicated | TDD-UL-DL-ConfigDedicated |
| OPTIONAL, -- Cond TDD | |
| initialDownlinkBWP | BWP-DownlinkDedicated |
| OPTIONAL, -- Need M | |
| downlinkBWP-ToReleaseList | SEQUENCE (SIZE (1..maxNrofBWPs)) OF BWP-Id |
| OPTIONAL, -- Need N | |
| downlinkBWP-ToAddModList | SEQUENCE (SIZE (1..maxNrofBWPs)) OF BWP-Downlink |
| OPTIONAL, -- Need N | |
| firstActiveDownlinkBWP-Id | BWP-Id |
| OPTIONAL, -- Cond SyncAndCellAdd | |
| bwp-InactivityTimer | ENUMERATED {ms2, ms3, ms4, ms5, ms6, ms8, ms10, ms20, ms30, |
| | ms40,ms50, ms60, ms80,ms100, ms200,ms300, ms500, |
| | ms750, ms1280, ms1920, ms2560, spare10, spare9, |
| spare8, | |
| | spare7, spare6, spare5, spare4, spare3, spare2, |
| spare1 } OPTIONAL, --Need R | |
| defaultDownlinkBWP-Id | BWP-Id |
| OPTIONAL, -- Need S | |
| uplinkConfig | UplinkConfig |
| OPTIONAL, -- Need M | |
| supplementaryUplink | UplinkConfig |
| OPTIONAL, -- Need M | |
| pdcch-ServingCellConfig | SetupRelease { PDCCH-ServingCellConfig } |
| OPTIONAL, -- Need M | |
| pdsch-ServingCellConfig | SetupRelease { PDSCH-ServingCellConfig } |
| OPTIONAL, -- Need M | |
| csi-MeasConfig | SetupRelease { CSI-MeasConfig } |
| OPTIONAL, -- Need M | |
| sCellDeactivationTimer | ENUMERATED {ms20, ms40, ms80, ms160, ms200, ms240, |
| | ms320, ms400, ms480, ms520, ms640, ms720, |
| | ms840, ms1280, spare2,spare1} OPTIONAL, - |
| - Cond ServingCellWithoutPUCCH | |
| crossCarrierSchedulingConfig | CrossCarrierSchedulingConfig |
| OPTIONAL, -- Need M | |
| tag-Id | TAG-Id, |
| dummy1 | ENUMERATED {enabled} |
| OPTIONAL, -- Need R | |
| pathlossReferenceLinking | ENUMERATED {spCell, sCell} |
| OPTIONAL, -- Cond SCellOnly | |
| servingCellMO | MeasObjectId |
| OPTIONAL, -- Cond MeasObject | |
| ..., | |
| [[ | |
| lte-CRS-ToMatchAround | SetupRelease { RateMatchPatternLTE-CRS } |
| OPTIONAL, -- Need M | |
| rateMatchPatternToAddModList | SEQUENCE (SIZE (1..maxNrofRateMatchPatterns)) OF |

RateMatchPattern OPTIONAL, -- Need N

| | |
|---|---|
| rateMatchPatternToReleaseList | SEQUENCE (SIZE (1..maxNrofRateMatchPatterns)) OF |

RateMatchPatternId OPTIONAL, -- Need N

| | |
|---|---|
| downlinkChannelBW-PerSCS-List | SEQUENCE (SIZE (1..maxSCSs)) OF SCS-SpecificCarrier |
| OPTIONAL -- Need S | |
| ]], | |
| [[ | |
| supplementaryUplinkRelease-r16 | ENUMERATED {true} |
| OPTIONAL, -- Need N | |

tdd-UL-DL-ConfigurationDedicated-IAB-MT-r16 TDD-UL-DL-ConfigDedicated-IAM-MT-r16

| | |
|---|---|
| OPTIONAL, -- Cond TDD_IAB | |
| dormantBWP-Config-r16 | SetupRelease { DormantBWP-Config-r16 } |
| OPTIONAL, -- Need M | |
| ca-SlotOffset-r16 | CHOICE { |
| refSCS15kHz | INTEGER (−2..2), |
| refSCS30kHz | INTEGER (−5..5), |
| refSCS60kHz | INTEGER (−10..10), |
| refSCS120kHz | INTEGER (−20..20) |
| } | |
| OPTIONAL, -- Cond AsyncCA | |
| dummy2 | SetupRelease { DummyJ } |
| OPTIONAL, -- Need M | |
| intraCellGuardBandsDL-List-r16 | SEQUENCE (SIZE (1..maxSCSs)) OF IntraCellGuardBandsPerSCS-r16 |
| OPTIONAL, -- Need S | |
| intraCellGuardBandsUL-List-r16 | SEQUENCE (SIZE (1..maxSCSs)) OF IntraCellGuardBandsPerSCS-r16 |
| OPTIONAL, -- Need S | |
| csi-RS-ValidationWithDCI-r16 | ENUMERATED {enabled} |
| OPTIONAL, -- Need R | |
| lte-CRS-PatternList1-r16 | SetupRelease { LTE-CRS-PatternList-r16 } |
| OPTIONAL, -- Need M | |
| lte-CRS-PatternList2-r16 | SetupRelease { LTE-CRS-PatternList-r16 } |
| OPTIONAL, -- Need M | |

crs-RateMatch-PerCORESETPoolIndex-r16 ENUMERATED {enabled}

| | |
|---|---|
| OPTIONAL, -- Need R | |
| enableTwoDefaultTCI-States-r16 | ENUMERATED {enabled} |
| OPTIONAL, -- Need R | |

enableDefaultTCI-StatePerCoresetPoolIndex-r16 ENUMERATED {enabled}

| | |
|---|---|
| OPTIONAL, -- Need R | |
| enableBeamSwitchTiming-r16 | ENUMERATED {true} |
| OPTIONAL, -- Need R | |
| cbg-TxDiffTBsProcessingType1-r16 | ENUMERATED {enabled} |
| OPTIONAL, -- Need R | |
| cbg-TxDiffTBsProcessingType2-r16 | ENUMERATED {enabled} |
| OPTIONAL -- Need R | |
| ]], | |
| [[ | |
| directionalCollisionHandling-r16 | ENUMERATED {enabled} |
| OPTIONAL, -- Need R | |
| channelAccessConfig-r16 | SetupRelease { ChannelAccessConfig-r16 } |
| OPTIONAL -- Need M | |
| ]] , | |
| [[ | |
| additionalPCIList-r17::= | SEQUENCE (SIZE(1..maxNrofAdditionalPCI)) OF SSB-MTC- |

AdditionalPCI-r17 OPTIONAL, -- Need R

| | |
|---|---|
| unifiedtci-StateType-r17 | ENUMERATED {SeparateULDL, JointULDL}, |
| OPTIONAL, -- Need R | |
| uplink-PowerControlToAddModList-r17 ::= | SEQUENCE (SIZE (1..maxULTCI-r17)) OF Uplink- |
| powerControl-r17 | OPTIONAL -- Need R |
| uplink-PowerControlToReleaseList-r17 ::= | SEQUENCE (SIZE (1..maxULTCI-r17)) OF Uplink- |
| powerControlId-r17 | OPTIONAL -- Need R |
| ]] | |
| } | |
| UplinkConfig ::= | SEQUENCE { |
| initialUplinkBWP | BWP-UplinkDedicated |
| OPTIONAL, -- Need M | |
| uplinkBWP-ToReleaseList | SEQUENCE (SIZE (1..maxNrofBWPs)) OF BWP-Id |
| OPTIONAL, -- Need N | |
| uplinkBWP-ToAddModList | SEQUENCE (SIZE (1..maxNrofBWPs)) OF BWP-Uplink |
| OPTIONAL, -- Need N | |
| firstActiveUplinkBWP-Id | BWP-Id |
| OPTIONAL, -- Cond SyncAndCellAdd | |
| pusch-ServingCellConfig | SetupRelease { PUSCH-ServingCellConfig } |
| OPTIONAL, -- Need M | |
| carrierSwitching | SetupRelease { SRS-CarrierSwitching } |
| OPTIONAL, -- Need M | |
| ..., | |
| [[ | |
| powerBoostPi2BPSK | BOOLEAN |
| OPTIONAL, -- Need M | |
| uplinkChannelBW-perSCS-List | SEQUENCE (SIZE (1..maxSCSs)) OF SCS-SpecificCarrier |
| OPTIONAL, -- Need S | |
| ]], | |
| [[ | |
| enablePL-RS-UpdateForPUSCH-SRS-r16 | ENUMERATED {enabled} |
| OPTIONAL, -- Need R | |
| enableDefaultBeamPL-ForPUSCH0-0-r16 | ENUMERATED {enabled} |
| OPTIONAL, -- Need R | |
| enableDefaultBeamPL-ForPUCCH-r16 | ENUMERATED {enabled} |
| OPTIONAL, -- Need R | |
| enableDefaultBeamPL-ForSRS-r16 | ENUMERATED {enabled} |
| OPTIONAL, -- Need R | |
| uplinkTxSwitching-r16 | SetupRelease { UplinkTxSwitching-r16 } |
| OPTIONAL, -- Need M | |
| mpr-PowerBoost-FR2-r16 | ENUMERATED {true} |
| OPTIONAL, -- Need R | |
| ]] | |
| } | |
| DummyJ ::= | SEQUENCE { |
| maxEnergyDetectionThreshold-r16 | INTEGER(−85..−52), |
| energyDetectionThresholdOffset-r16 | INTEGER (−20..−13), |
| ul-toDL-COT-SharingED-Threshold-r16 | INTEGER (−85..−52), |
| OPTIONAL, -- Need R | |
| absenceOfAnyOtherTechnology-r16 | ENUMERATED {true} |
| OPTIONAL -- Need R | |
| } | |
| ChannelAccessConfig-r16 ::= | SEQUENCE { |
| energyDetectionConfig-r16 | CHOICE { |
| maxEnergyDetectionThreshold-r16 | INTEGER (−85..−52), |
| energyDetectionThresholdOffset-r16 | INTEGER (−13..20) |
| } | |
| OPTIONAL, -- Need R | |
| ul-toDL-COT-SharingED-Threshold-r16 | INTEGER (−85..−52) |
| OPTIONAL, -- Need R | |
| absenceOfAnyOtherTechnology-r16 | ENUMERATED {true} |
| OPTIONAL -- Need R | |
| } | |
| IntraCellGuardBandsPerSCS-r16 ::= | SEQUENCE { |
| guardBandSCS-r16 | SubcarrierSpacing, |
| intraCellGuardBands-r16 | SEQUENCE (SIZE (1..4)) OF GuardBand-r16 |
| } | |
| GuardBand-r16 ::= | SEQUENCE { |
| startCRB-r16 | INTEGER (0..274), |
| nrofCRBs-r16 | INTEGER (0..15) |
| } | |
| DormancyGroupID-r16 ::= | INTEGER (0..4) |
| DormantBWP-Config-r16::= | SEQUENCE { |
| dormantBWP-Id-r16 | BWP-Id |
| OPTIONAL, -- Need M | |
| withinActiveTimeConfig-r16 | SetupRelease { WithinActiveTimeConfig-r16 } |
| OPTIONAL, -- Need M | |
| outsideActiveTimeConfig-r16 | SetupRelease { OutsideActiveTimeConfig-r16 } |
| OPTIONAL, -- Need M | |
| } | |
| WithinActiveTimeConfig-r16 ::= | SEQUENCE { |
| firstWithinActiveTimeBWP-Id-r16 | BWP-Id |
| OPTIONAL, --Need M | |
| dormancyGroupWithinActiveTime-r16 | DormancyGroupID-r16 |
| OPTIONAL -- Need R | |
| } | |
| OutsideActiveTimeConfig-r16 ::= | SEQUENCE { |
| firstOutsideActiveTimeBWP-Id-r16 | BWP-Id |
| OPTIONAL, -- Need M | |
| dormancyGroupOutsideActiveTime-r16 | DormancyGroupID-r16 |
| OPTIONAL -- Need R | |
| } | |
| UplinkTxSwitching-r16 ::= | SEQUENCE { |
| uplinkTxSwitchingPeriodLocation-r16 | BOOLEAN, |
| uplinkTxSwitchingCarrier-r16 | ENUMERATED {carrier1, carrier2) |
| } | |
| -- TAG-SERVINGCELLCONFIG-STOP | |
| -- AS1STOP | |

ChannelAccessConfig field descriptions

absenceOfAnyOtherTechnology
Presence of this field indicates absence on a long term basis (e.g. by level of regulation) of any other technology
sharing the carrier; absence of this field indicates the potential presence of any other technology sharing the carrier, as
specified in TS 37.213 [48] clauses 4.2.1 and 4.2.3.
energyDetectionConfig
Indicates whether to use the maxEnergyDetectionThreshold or the energyDetectionThresholdOffset (see TS 37.213
[48], clause 4.2.3).
energyDetectionThresholdOffset
Indicates the offset to the default maximum energy detection threshold value. Unit in dB. Value −13 corresponds
to −13 dB, value −12 corresponds to −12 dB, and so on (i.e. in steps of 1 dB) as specified in TS 37.213 [48], clause 4.2.3.
maxEnergyDetectionThreshold
Indicates the absolute maximum energy detection threshold value. Unit in dBm. Value −85 corresponds to −85 dBm,
value −84 corresponds to −84 dBm, and so on (i.e. in steps of 1 dBm) as specified in TS 37.213 [48], clause 4.2.3.
ul-toDL-COT-SharingED-Threshold
Maximum energy detection threshold that the UE should use to share channel occupancy with gNB for DL transmission
as specified in TS 37.213 [48], clause 4.1.3 for downlink channel access and clause 4.2.3 for uplink channel access.

ServingCellConfig field descriptions

additionalPCIList
List of timing information for the additional SSB with different PCI than serving cell PCI.
bwp-InactivityTimer
The duration in ms after which the UE falls back to the default Bandwidth Part (see TS 38.321 [3], clause 5.15). When
the network releases the timer configuration, the UE stops the timer without switching to the default BWP.
ca-SlotOffset
Slot offset between the primary cell (PCell/PSCell) and the SCell in unaligned frame boundary with slot alignment and
partial SFN alignment inter-band CA. Based on this field, the UE determines the time offset of the SCell as specified in
clause 4.5 of TS 38.211 [16]. The granularity of this field is determined by the reference SCS for the slot offset (i.e. the
maximum of PCell/PSCell lowest SCS among all the configured SCSs in DL/UL SCS-SpecificCarrierList in
ServingCellConfigCommon or ServingCellConfigCommonSIB and this serving cell's lowest SCS among all the
configured SCSs in DL/UL SCS-SpecificCarrierList in ServingCellConfigCommon or ServingCellConfigCommonSIB).
The Network configures at most single non-zero offset duration in ms (independent on SCS) among CCs in the
unaligned CA configuration. If the field is absent, the UE applies the value of 0. The slot offset value can only be
changed with SCell release and add.
cbg-TxDiffTBsProcessingType1, cbg-TxDiffTBsProcessingType2
Indicates whether processing types 1 and 2 based CBG based operation is enabled according to Rel-16 UE
capabilities.
channelAccessConfig
List of parameters used for access procedures of operation with shared spectrum channel access (see TS 37.213 [48).
crossCarrierSchedulingConfig
Indicates whether this serving cell is cross-carrier scheduled by another serving cell or whether it cross-carrier
schedules another serving cell.
crs-RateMatch-PerCORESETPoolIndex
Indicates how UE performs rate matching when both lte-CRS-PatternList1-r16 and lte-CRS-PatternList2-r16 are
configured as specified in TS 38.214 [19], clause 5.1.4.2.
csi-RS-ValidationWithDCI
Indicates how the UE performs periodic and semi-persistent CSI-RS reception in a slot. The presence of this field
indicates that the UE uses DCI detection to validate whether to receive CSI-RS (see TS 38.213 [13], clause 11.1).
defaultDownlinkBWP-Id
The initial bandwidth part is referred to by BWP-Id = 0. ID of the downlink bandwidth part to be used upon expiry of the
BWP inactivity timer. This field is UE specific. When the field is absent the UE uses the initial BWP as default BWP.
(see TS 38.213 [13], clause 12 and TS 38.321 [3], clause 5.15).
directionalCollisionHandling
Indicates that this serving cell is using directional collision handling between a reference and other cell(s) for half-duplex
operation in TDD CA with same SCS as specified in TS 38.213 [13], clause 11.1. The half-duplex operation only applies
within the same frequency range and cell group. The network only configures this field for TDD serving cells that are
using the same SCS.
dormantBWP-Config
The dormant BWP configuration for an SCell. This field can be configured only for a (non-PUCCH) SCell.
downlinkBWP-ToAddModList
List of additional downlink bandwidth parts to be added or modified. (see TS 38.213 [13], clause 12).
downlinkBWP-ToReleaseList
List of additional downlink bandwidth parts to be released. (see TS 38.213 [13], clause 12).
downlinkChannelBW-PerSCS-List
A set of UE specific channel bandwidth and location configurations for different subcarrier spacings (numerologies).
Defined in relation to Point A. The UE uses the configuration provided in this field only for the purpose of channel
bandwidth and location determination. If absent, UE uses the configuration indicated in scs-SpecificCarrierList in
DownlinkConfigCommon/DownlinkConfigCommonSIB. Network only configures channel bandwidth that corresponds
to the channel bandwidth values defined in TS 38.101-1 [15] and TS 38.101-2 [39].
dummy1, dummy 2
This field is not used in the specification. If received it shall be ignored by the UE.
enableBeamSwitchTiming
Indicates the aperiodic CSI-RS triggering with beam switching triggering behaviour as defined in clause 5.2.1.5.1 of TS
38.214 [19].
enableDefaultTCI-StatePerCoresetPoolIndex
Presence of this field indicates the UE shall follow the release 16 behavior of default TCI state per CORESETPoolindex
when the UE is configured by higher layer parameter PDCCH-Config that contains two different values of
CORESETPoolIndex in ControlResourceSet is enabled.
enable TwoDefaultTCI-States
Presence of this field indicates the UE shall follow the release 16 behavior of two default TCI states for PDSCH when at
least one TCI codepoint is mapped to two TCI states is enabled
firstActiveDownlinkBWP-Id
If configured for an SpCell, this field contains the ID of the DL BWP to be activated upon performing the RRC
(re-)configuration. If the field is absent, the RRC (re-)configuration does not impose a BWP switch.
If configured for an SCell, this field contains the ID of the downlink bandwidth part to be used upon activation of an
SCell. The initial bandwidth part is referred to by BWP-Id = 0.
Upon reconfiguration with reconfigurationWithSync, the network sets the firstActiveDownlinkBWP-Id and
firstActiveUplinkBWP-Id to the same value.
initialDownlinkBWP
The dedicated (UE-specific) configuration for the initial downlink bandwidth-part (i.e. DL BWP#0). If any of the optional
IEs are configured within this IE, the UE considers the BWP#0 to be an RRC configured BWP (from UE capability
viewpoint). Otherwise, the UE does not consider the BWP#0 as an RRC configured BWP (from UE capability
viewpoint). Network always configures the UE with a value for this field if no other BWPs are configured. NOTE1
intraCellGuardBandsDL-List, intraCellGuardBandsUL-List
List of intra-cell guard bands in a serving cell for operation with shared spectrum channel access. If not configured, the
guard bands are defined according to 38.101-1 [15], see TS 38.214 [19], clause 7. For operation in licensed spectrum,
this field is absent, and no UE action is required.
lte-CRS-PatternList1
A list of LTE CRS patterns around which the UE shall do rate matching for PDSCH. The LTE CRS patterns in this list
shall be non-overlapping in frequency. The network does not configure this field and lte-CRS-ToMatchAround
simultaneously.
lte-CRS-PatternList2
A list of LTE CRS patterns around which the UE shall do rate matching for PDSCH scheduled with a DCI detected on a
CORESET with CORESETPoolIndex configured with 1. This list is configured only if CORESETPoolIndex configured
with 1. The first LTE CRS pattern in this list shall be fully overlapping in frequency with the first LTE CRS pattern in lte-
CRS-PatternList1, The second LTE CRS pattern in this list shall be fully overlapping in frequency with the second LTE
CRS pattern in lte-CRS-PatternList1, and so on. Network configures this field only if the field lte-CRS-ToMatchAround is
not configured and there is at least one ControlResourceSet in one DL BWP of this serving cell with coresetPoolIndex
set to 1.
lte-CRS-ToMatchAround
Parameters to determine an LTE CRS pattern that the UE shall rate match around.
pathlossReferenceLinking
Indicates whether UE shall apply as pathloss reference either the downlink of SpCell (PCell for MCG or PSCell for
SCG) or of SCell that corresponds with this uplink (see TS 38.213 [13], clause 7).
pdsch-ServingCellConfig
PDSCH related parameters that are not BWP-specific.
rateMatchPatternToAddModList
Resources patterns which the UE should rate match PDSCH around. The UE rate matches around the union of all
resources indicated in the rate match patterns. Rate match patterns defined here on cell level apply only to PDSCH of
the same numerology. See TS 38.214 [19], clause 5.1.4.1.
sCellDeactivationTimer
SCell deactivation timer in TS 38.321 [3]. If the field is absent, the UE applies the value infinity.
servingCellMO
measObjectId of the MeasObjectNR in MeasConfig which is associated to the serving cell. For this MeasObjectNR, the
following relationship applies between this MeasObjectNR and frequencyInfoDL in ServingCellConfigCommon of the
serving cell: if ssbFrequency is configured, its value is the same as the absoluteFrequencySSB and if csi-rs-
ResourceConfigMobility is configured, the value of its subcarrierSpacing is present in one entry of the scs-
SpecificCarrierList, csi-RS-CellListMobility includes an entry corresponding to the serving cell (with cellId equal to
physCellId in ServingCellConfigCommon) and the frequency range indicated by the csi-rs-MeasurementBW of the entry
in csi-RS-CellListMobility is included in the frequency range indicated by in the entry of the scs-SpecificCarrierList.
supplementaryUplink
Network may configure this field only when supplementaryUplinkConfig is configured in ServingCellConfigCommon or
supplementaryUplink is configured in ServingCellConfigCommonSIB.
supplementaryUplinkRelease
If this field is included, the UE shall release the uplink configuration configured by supplementaryUplink. The network
only includes either supplementaryUplinkRelease or supplementaryUplink at a time.
tag-Id
Timing Advance Group ID, as specified in TS 38.321 [3], which this cell belongs to.
tdd-UL-DL-ConfigurationDedicated-IAB-MT
Resource configuration per IAB-MT D/U/F overrides all symbols (with a limitation that effectively only flexible symbols
can be overwritten in Rel-16) per slot over the number of slots as provided by TDD-UL-DL ConfigurationCommon.
unifiedtci-StateType
Indicates the unified TCI state type the UE is configured for this serving cell. The value “SeparateULDL” means this
serving cell is configured with DLorJoint-TCIState for DL TCI state and UL-TCIState for UL TCI state. The value
“JointULDL” means this serving cell is configured with DLorJoint-TCIState for joint TCI state for UL and DL operation.
uplinkConfig
Network may configure this field only when uplinkConfigCommon is configured in ServingCellConfigCommon or
ServingCellConfigCommonSIB. Addition or release of this field can only be done upon SCell addition or release
(respectively).
uplink-PowerControlToAddModList
Configures UL power control parameters for PUSCH, PUCCH and SRS when field unifiedtci-State Type is configured.
Network does not configure other uplink power control parameters configured in IEs PUCCH-PowerControl, PUSCH-
PowerControl or SRS-Config for the UE when this is configured.

CellGroupConfig field descriptions

bap-Address
BAP address of the parent node in cell group.
bh-RLC-ChannelToAddModList
Configuration of the backhaul RLC entities and the corresponding MAC Logical Channels to be added and modified.
bh-RLC-ChannelToReleaseList
List of the backhaul RLC entities and the corresponding MAC Logical Channels to be released.
f1c-TransferPath
The F1-C transfer path that an EN-DC IAB-MT should use for transferring F1-C packets to the IAB-donor-CU. If IAB-MT
is configured with lte, IAB-MT can only use LTE leg for F1-C transfer. If IAB-MT is configured with nr, IAB-MT can only
use NR leg for F1-C transfer. If IAB-MT is configured with both, it is up to IAB-MT to select an LTE leg or a NR leg for
F1-C transfer. If the field is not configured, the IAB node uses the NR leg as the default one.
mac-CellGroupConfig
MAC parameters applicable for the entire cell group.
rlc-BearerToAddModList
Configuration of the MAC Logical Channel, the corresponding RLC entities and association with radio bearers.
reportUplinkTxDirectCurrent
Enables reporting of uplink and supplementary uplink Direct Current location information upon BWP configuration and
reconfiguration. This field is only present when the BWP configuration is modified or any serving cell is added or
removed. This field is absent in the IE CellGroupConfig when provided as part of RRCSetup message. If UE is
configured with SUL carrier, UE reports both UL and SUL Direct Current locations.
reportUplinkTxDirectCurrentTwoCarrier
Enables reporting of uplink Direct Current location information when the UE is configured with uplink intra-band CA with
two carriers. This field is absent in the IE CellGroupConfig when provided as part of RRCSetup message.
riminSyncOutOfSyncThreshold
BLER threshold pair index for IS/OOS indication generation, see TS 38.133 [14], table 8.1.1-1. n1 corresponds to the
value 1. When the field is absent, the UE applies the value 0. Whenever this is reconfigured, UE resets N310 and N311,
and stops T310, if running. Network does not include this field.
sCellState
Indicates whether the SCell shall be considered to be in activated state upon SCell configuration.
sCellToAddModList
List of secondary serving cells (SCells) to be added or modified.
sCellToReleaseList
List of secondary serving cells (SCells) to be released.
secondaryDRX-GroupConfig
The field is used to indicate whether the SCell belongs to the secondary DRX group. All serving cells in the secondary
DRX group shall belong to one Frequency Range and all serving cells in the legacy DRX group shall belong to another
Frequency Range.
simultaneous TCI-UpdateList1, simultaneous TCI-UpdateList2
List of serving cells which can be updated simultaneously for TCI relation with a MAC CE. The simultaneous TCI-
UpdateList1 and simultaneous TCI-UpdateList2 shall not contain same serving cells. Network should not configure
serving cells that are configured with a BWP with two different values for the coresetPoolIndex in these lists.
simultaneousSpatial-UpdatedList1, simultaneousSpatial-UpdatedList2
List of serving cells which can be updated simultaneously for spatial relation with a MAC CE. The simultaneousSpatial-
UpdatedList1 and simultaneousSpatial-UpdatedList2 shall not contain same serving cells. Network should not configure
serving cells that are configured with a BWP with two different values for the coresetPoolIndex in these lists.
spCellConfig
Parameters for the SpCell of this cell group (PCell of MCG or PSCell of SCG).
uplinkTxSwitchingOption
Indicates which option is configured for dynamic UL Tx switching for inter-band UL CA or (NG)EN-DC. The field is set to
switchedUL if network configures option 1 as specified in TS 38.214 [19], or dualUL if network configures option 2 as
specified in TS 38.214 [19]. Network always configures UE with a value for this field in inter-band UL CA case and
(NG)EN-DC case where UE supports dynamic UL Tx switching.
uplinkTxSwitchingPowerBoosting
Indicates whether the UE is allowed to enable 3 dB boosting on the maximum output power for transmission on carrier2
under the operation state in which 2-port transmission can be supported on carrier2 for inter-band UL CA case with
dynamic UL Tx switching as defined in TS 38.101-1 [15]. Network can only configure this field for dynamic UL Tx
switching in inter-band UL CA case with power Class 3 as defined in TS 38.101-1 [15].

DAPS-UplinkPowerConfig field descriptions

p-DAPS-Source
The maximum total transmit power to be used by the UE in the source cell
group during DAPS handover.
p-DAPS-Target
The maximum total transmit power to be used by the UE in the target cell
group during DAPS handover.
uplinkPowerSharingDAPS-Mode
Indicates the uplink power sharing mode that the UE uses in DAPS
handover (see TS 38.213 [13]).

ReconfigurationWithSync field descriptions

rach-ConfigDedicated
Random access configuration to be used for the reconfiguration with sync (e.g. handover). The UE performs the RA
according to these parameters in the firstActiveUplinkBWP (see UplinkConfig).
smtc
The SSB periodicity/offset/duration configuration of target cell for NR PSCell change and NR PCell change. The
network sets the periodicityAndOffset to indicate the same periodicity as ssb-periodicityServingCell in
spCellConfigCommon.
For case of NR PCell change, the smtc is based on the timing reference of (source) PCell. For case of NR PSCell
change, it is based on the timing reference of source PSCell.
If both this field and targetCellSMTC-SCG are absent, the UE uses the SMTC in the measObjectNR having the same
SSB frequency and subcarrier spacing, as configured before the reception of the RRC message.

SCellConfig field descriptions

smtc
The SSB periodicity/offset/duration configuration of target cell for NR SCell addition. The network sets the
periodicityAndOffset to indicate the same periodicity as ssb-periodicityServingCell in sCellConfigCommon. The smtc is
based on the timing of the SpCell of associated cell group. In case of inter-RAT handover to NR, the timing reference is
the NR PCell. In case of intra-NR PCell change (standalone NR) or NR PSCell change (EN-DC), the timing reference is
the target SpCell. If the field is absent, the UE uses the SMTC in the measObjectNR having the same SSB frequency
and subcarrier spacing, as configured before the reception of the RRC message.

SpCellConfig field descriptions

reconfigurationWithSync
Parameters for the synchronous reconfiguration to the target SpCell.
rlf-TimersAndConstants
Timers and constants for detecting and triggering cell-level radio link
failure. For the SCG, rlf-TimersAndConstants can only be set to setup
and is always included at SCG addition.
servCellIndex
Serving cell ID of a PSCell. The PCell of the Master Cell Group uses
ID = 0.

| Conditional Presence | Explanation |
|---|---|
| BWP-Reconfig | The field is optionally present, Need N, if the BWPs are reconfigured or if serving |
| | cells are added or removed. Otherwise it is absent. |
| DRX-Config2 | The field is optionally present, Need N, if drx-ConfigSecondaryGroup is configured. It |
| | is absent otherwise. |
| ReconfWithSync | The field is mandatory present in the RRCReconfiguration message: |
| | in each configured CellGroupConfig for which the SpCell changes, |
| | in the masterCellGroup: |
| | at change of AS security key derived from K_{gNB}, |
| | in an RRCReconfiguration message contained in a |
| | DLInformation TransferMRDC message, |
| | in the secondaryCellGroup at: |
| | PSCell addition, |
| | SCG resume with NR-DC or (NG)EN-DC, |
| | update of required SI for PSCell, |
| | change of AS security key derived from S-K_{gNB} in NR-DC while the UE is |
| | configured with at least one radio bearer with keyToUse set to secondary |
| | and that is not released by this RRCReconfiguration message, |
| | MN handover in (NG)EN-DC. |
| | Otherwise, it is optionally present, need M. The field is absent in the |
| | masterCellGroup in RRCResume and RRCSetup messages and is absent in the |
| | masterCellGroup in RRCReconfiguration messages if source configuration is not |
| | released during DAPS handover. |
| SCellAdd | The field is mandatory present upon SCell addition; otherwise it is absent, Need M. |
| SCellAddMod | The field is mandatory present upon SCell addition; otherwise it is optionally present, |
| | need M. |
| SCellAddSync | The field is optionally present, Need N, in case of SCell addition, reconfiguration with |
| | sync, and resuming an RRC connection. It is absent otherwise. |
| SCG | The field is mandatory present in an SpCellConfig for the PSCell. It is absent |
| | otherwise. |

NOTE:
In case of change of AS security key derived from S-K_{gNB}/S-K_{eNB}, if reconfigurationWithSync is not included in the masterCellGroup, the network releases all existing MCG RLC bearers associated with a radio bearer with keyToUse set to secondary. In case of change of AS security key derived from K_{gNB}/K_{eNB}, if reconfigurationWithSync is not included in the secondaryCellGroup, the network releases all existing SCG RLC bearers associated with a radio bearer with keyToUse set to primary.

### RACH-ConfigGeneric

The IE RACH-ConfigGeneric is used to specify the random-access parameters both for regular random access as well as for beam failure recovery.

### RACH-ConfigGeneric Information Element

-- ASN1START
-- TAG-RACH-CONFIGGENERIC-START

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |
| msg1-FrequencyStart | INTEGER (0..maxNrofPhysicalResourceBlocks-1), |
| zeroCorrelationZoneConfig | INTEGER (0..15), |
| preambleReceivedTargetPower | INTEGER (−202..−60), |
| preambleTransMax | ENUMERATED {n3, n4, n5, n6, n7, n8, n10, n20, n50, n100, |
| n200}, | |
| powerRampingStep | ENUMERATED {dB0, dB2, dB4, dB6}, |
| ra-ResponseWindow | ENUMERATED {sl1, sl2, sl4, sl8, sl10, sl20, sl40, sl80}, |
| ..., | |
| [[ | |
| prach-ConfigurationPeriodScaling-IAB-r16 | ENUMERATED {scf1, scf2, scf4, scf8, scf16, scf32, scf64} |
| OPTIONAL, -- Need R | |
| prach-ConfigurationFrameOffset-IAB-r16 | INTEGER (0..63) |
| OPTIONAL, -- Need R | |
| prach-ConfigurationSOffset-IAB-r16 | INTEGER (0..39) |
| OPTIONAL, -- Need R | |
| ra-ResponseWindow-v1610 | ENUMERATED { sl60, sl160} |
| OPTIONAL, -- Need R | |
| prach-ConfigurationIndex-v1610 | INTEGER (256..262) |
| OPTIONAL -- Need R | |
| ]], | |
| [[ | |
| ra-ResponseWindow-v1700 | ENUMERATED {sl240, sl320, sl640, sl960, sl1280, |
| sl1920, sl2560} OPTIONAL -- Need R | |
| ]] | |
| } | |
| -- TAG-RACH-CONFIGGENERIC-STOP | |
| -- ASN1STOP | |

RACH-ConfigGeneric field descriptions

msg1-FDM
The number of PRACH transmission occasions FDMed in one time instance. (see TS 38.211 [16], clause 6.3.3.2).
msg1-FrequencyStart
Offset of lowest PRACH transmission occasion in frequency domain with respective to PRB 0. The value is configured
so that the corresponding RACH resource is entirely within the bandwidth of the UL BWP. (see TS 38.211 [16], clause
6.3.3.2).
powerRampingStep
Power ramping steps for PRACH (see TS 38.321 [3], 5.1.3).
prach-ConfigurationFrameOffset-IAB
Frame offset for ROs defined in the baseline configuration indicated by prach-ConfigurationIndex and is used only by
the IAB-MT. (see TS 38.211 [16], clause 6.3.3.2).
prach-ConfigurationIndex
PRACH configuration index. For prach-ConfigurationIndex configured under beamFailureRecoveryConfig, the prach-
ConfigurationIndex can only correspond to the short preamble format, (see TS 38.211 [16], clause 6.3.3.2). If the field
prach-ConfigurationIndex-v1610 is present, the UE shall ignore the value provided in prach-ConfigurationIndex (without
suffix).
prach-ConfigurationPeriodScaling-IAB
Scaling factor to extend the periodicity of the baseline configuration indicated by prach-ConfigurationIndex and is used
only by the IAB-MT. Value scf1 corresponds to scaling factor of 1 and so on. (see TS 38.211 [16], clause 6.3.3.2).
prach-ConfigurationSOffset-IAB
Subframe/Slot offset for ROs defined in the baseline configuration indicated by prach-ConfigurationIndex and is used
only by the IAB-MT. (see TS 38.211 [16], clause 6.3.3.2).
preambleReceivedTargetPower
The target power level at the network receiver side (see TS 38.213 [13], clause 7.4, TS 38.321 [3], clauses 5.1.2, 5.1.3).
Only multiples of 2 dBm may be chosen (e.g. −202, −200, −198, . . .).
preamble TransMax
Max number of RA preamble transmission performed before declaring a failure (see TS 38.321 [3], clauses 5.1.4,
5.1.5).
ra-ResponseWindow
Msg2 (RAR) window length in number of slots. The network configures a value lower than or equal to 10 ms when Msg2
is transmitted in licensed spectrum and a value lower than or equal to 40 ms when Msg2 is transmitted with shared
spectrum channel access (see TS 38.321 [3], clause 5.1.4). UE ignores the field if included in SCellConfig. If ra-
ResponseWindow-v1610 or ra-ResponseWindow-v1700 is signalled, UE shall ignore the ra-ResponseWindow (without
suffix). The field ra-ResponseWindow-v1700 is applicable to SCS 480 kHz and SCS 960 kHz.
zeroCorrelationZoneConfig
N-CS configuration, see Table 6.3.3.1-5 in TS 38.211 [16].

In New WID on N_{R} (e.g., [3] RP-212710 New WID on NR further mobility enhancements), further mobility enhancements, objectives for enhancement on mobility for NR are discussed:

### 3 Justification

When the UE passes from the coverage area of one cell to another cell, at some point a serving cell change need to be performed. Currently serving cell change is triggered by L3 measurements and is done by RRC signalling triggered Reconfiguration with Synch for change of PCell and PSCell, as well as release add for SCells when applicable, all cases with complete L2 (and L1) resets, and involving more latency, more overhead and more interruption time than beam switch mobility. The goal of L1/L2 mobility enhancements is to be able to do serving cell change via L1/L2 signalling with such low latency, low overhead and low interruption time.

In Rel-17 Conditional PSCell change (CPC)/Conditional PSCell change/addition (CPAC), a CPC/CPAC configured UE has to release the CPC/CPAC configurations when performing the random access to the target PSCell. Hence the UE doesn't have a chance to perform subsequent CPC/CPAC without reconfiguration and re-initialization on the CPC/CPAC from the network, which will delay the cell change and increase the signaling overhead, especially in the case of frequent SCG change operating on FR2. Therefore, MR-DC with selective activation of cell groups is aimed to allow allowing subsequent CPC/CPAC after changing SCG, without reconfiguration and re-initialization on the CPC/CPAC preparation from the network, which can reduce the signaling overhead and interrupting time for CPC/CPAC.

Currently CHO and MR-DC cannot be configured simultaneously. This limits the usefulness of these two features when MR-DC is configured. If it is not completed in Rel-17, Rel-18 should specify mechanisms for CHO and MR-DC to be configured simultaneously. However, it may not be enough as the radio link quality of the configured PSCell may not be good enough or may not be the best candidate PSCell when the UE access the target PCell. Thus it will impact the throughput of the UE and Rel-18 CHO+MRDC can consider CHO including target MCG and multiple candidate SCG for CPC/CPAC to further improve the CHO performance.

### 4 Objective

### 4.1 Objective of Core Part WI

The detailed objective of this work item are:
To specify mechanism and procedures of L1/L2 based inter-cell mobility for mobility latency reduction:
Configuration and maintenance for multiple candidate cells to allow fast application of configurations for candidate cells [RAN2, RAN3]
Dynamic switch mechanism among candidate serving cells (including SpCell and SCell) for the potential applicable scenarios based on L1/L2 signalling [RAN2, RAN1]
L1 enhancements, including inter-cell beam management, L1 measurement and reporting, beam indication, and for non-synchronized scenario to handle TA management [RAN1, RAN2]
CU-DU interface signaling to support L1/L2 mobility, if needed [RAN3]
   Note 1: FR2 specific enhancements are not precluded, if any.
   Note 2: The procedure of L1/L2 based inter-cell mobility are applicable to the following scenarios:
      Standalone, CA and NR-DC case with serving cell change within one CG
      Intra-CU case and intra-CU inter-DU case (applicable for Standalone and CA)
      Both intra-frequency and inter-frequency
      Both FR1 and FR2
To specify mechanism and procedures of MR-DC with selective activation of the cell groups via L3 enhancements:
To allow subsequent CPC/CPAC after changing SCG without reconfiguration and re-initiation of CPC/CPAC [RAN2, RAN3, RAN4]
TBD: whether Rel-17 CPC/CPAC mechanism is used as the baseline
TBD: whether to limit MR-DC to EN-DC and NR-DC
To specify CHO including target MCG and target SCG if it cannot be completed in Rel-17 [RAN3, RAN2]
To specify CHO including target MCG and candidate SCG for CPC/CPAC [RAN3, RAN2]
CHO including target MCG and target SCG is used as the baseline

In 3GPP spec 38.300 running CR for introduction of NR further mobility enhancements (e.g., [4] R2-2213332 38.300 running CR for introduction of NR further mobility enhancements), L1/L2-triggered mobility (LTM) is introduced:

### 9.2.3.x L1/L2-Triggered Mobility

### 9.2.3.x.1 General

LTM is a procedure in which a gNB receives L1 measurement reports from UEs, and on their basis the gNB changes UEs' serving cell(s) through MAC CE. The gNB prepares one or multiple candidate cells and provides the candidate cell configurations to the UE through RRC message. Then LTM cell switch is triggered, by selecting one of the candidate configurations as target configuration for LTM by the gNB. The candidate cell configurations can only be added, modified and released by network via RRC signaling.

Editors' note: FFS later whether some optimization should be applied e.g. for release.

Editor's note: Current options to configure a LTM candidate cell:
a. One RRCReconfiguration message for candidate target cell
b. One CellGroupConfig IE for each candidate target cell

The following principles apply to LTM:
Candidate cell configuration can be provided as delta configurations on top of a reference configuration. The reference configuration is managed separately, and a UE stores the reference configuration as a separate configuration.
User plane is continued whenever possible (e.g. intra-DU), without reset, with the target to avoid data loss and the additional delay of data recovery.
   Security is not updated in LTM.
   Subsequent LTM between candidates (i.e., UE does not release other candidate cell configurations after LTM is triggered) can be performed without RRC reconfiguration.

LTM supports both intra-gNB-DU and intra-gNB-CU inter-gNB-DU mobility. LTM also supports inter-frequency mobility, including mobility to inter-frequency cell that is not a current serving cell. The following scenarios are supported:
PCell change in non-CA scenario,
PCell change without SCell change in CA scenario,
PCell change with SCell change(s) in CA scenario, including the following cases:
   a) The target PCell/target SCell(s) is not a current serving cell (CA-to-CA scenario with PCell change)
   b) The target PCell is a current SCell
   c) The target SCell is the current PCell.
Dual connectivity scenario, at least for the PSCell change without MN involvement case, i.e. intra-SN.

Inter-cell beam management is also supported, but is not considered as a prerequisite for using LTM.

Editor's note: The design for intra-DU and inter-DU L1/L2-based mobility should share as much commonality as reasonable. FFS which aspects need to be different.

Editor's note: FFS whether ASN.1 decoding and validity/compliance check of candidate cell configuration are performed upon reception of the candidate cells configuration, and if this needs to be specified.

### 9.2.3.x.2 C-Plane Handling

Cell switch trigger information is conveyed in a MAC CE, which contains at least a candidate configuration index. Cell-specific, radio bearer, and measurement configurations can be part of an LTM candidate cell configuration.

Editor's note: FFS if the MAC CE can indicate TCI state(s) (or other beam info) to be activate for the target Cell(s)

Editor's note: FFS if it should be possible to perform SCell activation/deactivation (amongst SCells associated with the candidate configuration) simultaneously with the LTM triggering MAC CE.

UE may perform CBRA or CFRA at cell switch. UE may also skip random access procedure if UE doesn't need to acquire TA for the target cell during cell switch. RACH resources for CFRA are provided in RRC configuration.

Editor's note: FFS if the CFRA resources can be provide via MAC CE.

The overall procedure for LTM is shown in Figure x below. Subsequent LTM is done by repeating the early synchronization, LTM execution, and LTM completion steps without releasing other candidates after each LTM completion.

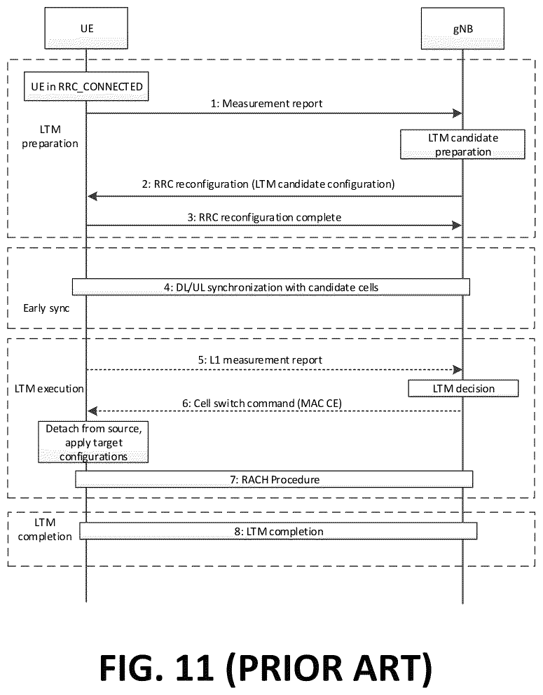

FIG. 11 is a reproduction of Figure x. Signaling procedure for LTM, from R2-2213332 38.300 running CR for introduction of N_{R} further mobility enhancements.

The procedure for LTM is as follows.

1. The UE sends a MeasurementReport message to the gNB. The gNB decides to use LTM and initiates LTM candidate preparation.

2. The gNB transmits an RRCReconfiguration message to the UE including the configuration of one or multiple LTM candidate target cells.

3. The UE stores the configuration of LTM candidate target cell(s) and transmits a RRCReconfigurationComplete message to the gNB.

4. The UE may perform DL synchronization and TA acquisition with candidate target cell(s) before receiving the LTM cell switch command.

Editor's note: DL synchronization for candidate cell(s) before cell switch command is supported, at least based on SSB. FFS necessary mechanism.

Editor's note: TA acquisition of candidate cell(s) before LTM cell switch command is supported, at least based on PDCCH ordered RACH, where the PDCCH order is only triggered by source cell. FFS detailed mechanism.

5. The UE performs L1 measurements on the configured LTM candidate target cell(s), and transmits lower-layer measurement reports to the gNB.

6. The gNB decides to execute LTM cell switch to a target cell, and transmits a MAC CE triggering LTM cell switch by including the candidate configuration index of the target cell. The UE switches to the configuration of the LTM candidate target cell.

Editor's note: FFS how beam indication is done.

7. The UE performs random access procedure towards the target cell, if TA is not available.

8. The UE indicates successful completion of the LTM cell switch towards target cell. uplink signal or message after the UE has switched to the target cell is used to indicate successful completion of the LTM cell switch.

### 9.2.3.x.3 U-Plane Handling

In LTM, whether the UE performs partial or full MAC reset, re-establish RLC, performs data recovery with PDCP during cell swith is explicitly controlled by the network.

Editor's note: ON the determination of whether to reset L2: two options on the table:
1) The UE determines whether the switch is intra DU or inter DU and the follows different rule or configuration for these two cases which controls whether to reset or not reset. Determination could be based on configuration (e.g. of a DU ID, cell group id etc)
2) The UE receives command to reset or not reset by MAC CE.

Editor's note: FFS what partial reset is.

Editor's note: For UE processing, the following (not exhaustive) is assumed to be performed after receiving the cell switch command:
1. MAC/RLC reset (when configured)
2. RF retuning (e.g. needed for inter-frequency), baseband retuning

Editor's note: FFS how the UE determine the BWPs (for DL and UL) to be used upon the execution of L1/L2 inter-cell mobility.
In 3GPP RAN1 #110b-e meeting (e.g., [5] 3GPP RAN1 #110b report), following agreements have been made regarding obtaining TA for candidate cells before LTM:

### Agreement

Support TA acquisition of candidate cell(s) before cell switch command is received in L1/L2 based mobility.
FFS: whether this can be applied to candidate cell when it is deactivated SCell (if defined in RAN2).

From October 19th GTW session

### Agreement

On mechanism to acquire TA of the candidate cells, the following solutions can be further studied:
RACH-based solutions
   e.g., PDCCH ordered RACH, UE-triggered RACH, higher layer triggered RACH from NW other than L3 HO cmd
RACH-less solutions
   e.g., SRS based TA acquisition, Rx timing difference based, RACH-less mechanism as in LTE, UE based TA measurement (including UE based TA measurement with one TAC from serving cell)

### Agreement

For TA acquisition of a candidate cell before cell switch command is received, study at least the following alternatives of associating TA/TAG to candidate cell:
Alt1: Associate TA/TAG and candidate cell implicitly, e.g.,
   the association between TA/TAG and TCI states can be configured.
Alt2: Associate TA/TAG and candidate cell explicitly, e.g.,
   the association is provided as a part of candidate cell(s) configuration
   the association between TA/TAG and SSB(s)/TRS(s) is provided as a part of candidate cell(s) configuration
In 3GPP RAN1 #112 meeting (e.g., [6] 3GPP RAN1 #112 report), agreement has been made regarding PDCCH ordered-RACH for candidate cell(s):

### Agreement

For PDCCH ordered-RACH for candidate cell(s), RAR reception can be configured/indicated
If reception of RAR is not configured/indicated (without RAR)
   TA value of candidate cell is indicated in cell switch command
   FFS: whether UE should re-transmit PRACH when reception of RAR is not configured/indicated
   FFS: how UE determine the transmit power of subsequent PRACH triggered by PDCCH order
If reception of RAR is configured/indicated (with RAR), FFS
   whether RAR is received from-serving cell or candidate cell
      if RAR is received from candidate cell, whether Type1-PDCCH CSS of the candidate cell is configured to the UE
   content of RAR
FFS: signaling for configuration/indication of whether RAR needs to be received
UE can report the support combination of with RAR only and without RAR only, where support of one default scheme is the baseline UE approach for LTM.
Send LS to RAN2 and RAN3 to check the feasibility about this agreement
Note: Definition of candidate cells is up to RAN2

### Agreement

For PDCCH-order based RACH for TA measurement for candidate cells, legacy CBRA is not supported

### Agreement

On whether UE should initiate re-transmit PRACH when reception of RAR is not configured/indicated, down select one from the following alternatives.
Alt 1: UE autonomous re-transmission of PRACH is not allowed (e.g., by setting the number of allowed PRACH transmission to the minimum value of Preamble TransMax=1).
Alt 2: UE autonomous Re-transmission of PRACH is allowed,

The number of PRACH transmission will be defined e.g. set the times of RACH transmission to the minimum value of Preamble TransMax

### Agreement

If reception of RAR is configured/indicated, RAR contains at least TA of candidate cell.
The maximum number of TA values memorized by UE is a UE capability
FFS: whether other parameters such as UE ID, candidate cell ID etc. is contained in RAR

### Agreement

Whether RAR needs to be received is configured by RRC.
In RAN2 #121bis meeting (e.g., [7] 3GPP RAN2 #121bis report), agreements have been made regarding LTM:
   From RAN2 perspective, to enable shared preamble resource among multiple UEs, it is beneficial that the information that identifies the allocated CFRA resource (i.e., SS/PBCH index, RACH occasion, and Random Access Preamble index) can be indicated in the PDCCH order (as legacy intra-cell PDCCH order).
   RRC RACH configuration for early TA acquisition (e.g., including whether RAR needs to be received) is specific per target cell and is signalled separately (separate IEs) from the candidate cell configuration (the part that need to be applied at cell switch).
   R2 assumes that Early TA RACH option 3 (with RAR from candidate cell) is not needed in Rel-18.
   R2 assumes RRCReconfigurationComplete message is always sent at each LTM execution.
   In RACH-based LTM, the target cell is aware of the UE's arrival based on the reception of preamble in CFRA and on the reception of Msg3/MsgA in CBRA, like the legacy HO.
   In RACH-less LTM, the target cell is aware of the UE's arrival based on reception of the first UL transmission from this UE
   In RACH-less LTM, RRCReconfigurationComplete can be the content of the first UL MAC PDU/transmission to indicate UE arrival, i.e. no need to introduce any new signaling to indicate UE arrival (for the MCG-switch case)
   For RACH-based LTM, the UE considers that LTM execution procedure is successfully completed when the RACH is successfully completed.
   For RACH-less LTM, the UE considers that LTM execution procedure is successfully complete when the UE determines the NW has successfully received its first UL data.
   Following behaviors of LTM supervisor timer are agreed:
      1: The UE starts the LTM supervisor timer, upon reception of the LTM cell switch MAC CE;
      2: The UE stops the LTM supervisor timer, upon successful completion of LTM cell switch;
      3: If the LTM supervisor timer for MCG expires, as baseline, the UE considers LTM failure and initiates RRC re-establishment. (SCG switch case FFS)
   LTM supervisor timer is RRC layer timer.
   At RLF or LTM execution failure (for MCG), RAN2 intend to support fast recovery to a candidate cell by LTM execution.
   While configured with LTM candidate cells, the UE can also execute any L3 handover command sent by the network. R2 assumes that is could be up to the network to avoid any issue due to the race condition between LTM execution and RRC Reconfiguration (e.g. L3 HO cmd), e.g. avoid sending LTM switch cmd and L3 HO cmd in the same TB.
In 3GPP RAN2 #122 meeting (e.g., [8] 3GPP RAN2 #122 report), an agreement was made regarding TA maintenance for candidate Cells for LTM:
   Dynamic grant can be used for RACH-less LTM, for the first UL data transmission to the target cell:
      the UE monitors PDCCH for dynamic scheduling from the target cell, upon LTM cell switch.
      upon cell switch decision, R2 assumes that the source DU informs the target DU about the selected beam, so that the target DU can start scheduling dynamic UL grant.
   Configured grant can be used for RACH-less LTM, for the first UL data transmission to the target cell, the UE selects the configured grant occasion, which is associated with the beam indicated in the LTM MAC CE (as set by source cell). FFS further optimization
   If the TA maintenance etc for candidate cell(s) in the UE is needed, the TA(s) associated with candidate cell(s) can be maintained during LTM (TDB exactly which cells decide stage-3).
In 3GPP specification 38.211 (e.g., [9] 3GPP 38.211 v17.1.0), timing advance is introduced:
   N_{TA} Timing advance between downlink and uplink; see clause 4.3.1
   N_{TA,offset} A fixed offset used to calculate the timing advance; see clause 4.3.1

### 4.3.1 Frames and Subframes

Downlink, uplink, and sidelink transmissions are organized into frames with T_{f}=(Δfₘₐₓ N_{f}/100)·T_{c}=10 ms duration, each consisting of ten subframes of T_{sf}=(Δfₘₐₓ N_{f}/1000)·T_{c}=1 ms duration. The number of consecutive OFDM symbols per subframe is N_{symb}^{subframe,μ}=N_{symb}^{slot}Nₛₗₒₜ^{subframe,μ}. Each frame is divided into two equally-sized half-frames of five subframes each with half-frame 0 consisting of subframes 0-4 and half-frame 1 consisting of subframes 5-9.

There is one set of frames in the uplink and one set of frames in the downlink on a carrier.

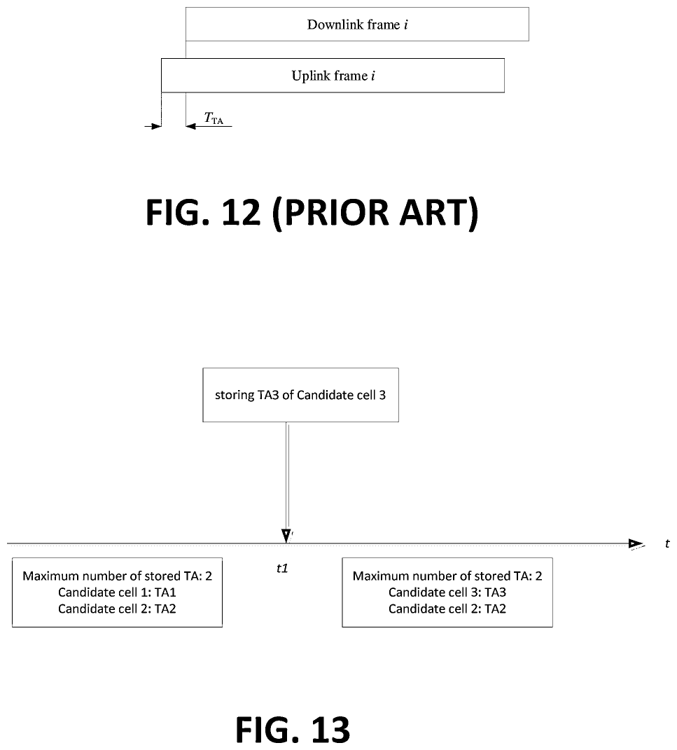

Uplink frame number i for transmission from the UE shall start T_{TA}=(N_{TA}+N_{TA,offset}+N_{TA,adj}^{common}+N_{TA,adj}^{UE})T_{c} before the start of the corresponding downlink frame at the UE where
N_{TA} and N_{TA,offset} are given by clause 4.2 of [5, TS 38.213], except for msgA transmission on PUSCH where N_{TA}=0 shall be used;
N_{TA,adj}^{common} is derived from the higher-layer parameters TACommon, TACommonDrift, and TACommonDriftVariation if configured, otherwise N_{TA,adj}^{common}=0;
N_{TA,adj}^{UE} is computed by the UE based on UE position and serving-satellite-ephemeris-related higher-layers parameters if configured, otherwise N_{TA,adj}^{UE}=0.
   FIG. 12 is a reproduction of FIG. 4.3.1-1: Uplink-downlink timing relation, from 3GPP 38.211 v17.1.0.

In New Radio (N_{R}), a User Equipment (UE) performs a handover procedure to switch from one cell (e.g., a source Cell) to another cell (e.g., a target Cell). The UE performs the handover procedure in response to a Radio Resource Control (RRC) signaling transmitted by a network. The RRC signaling contains cell information of a target cell. The network determines to initiate the handover procedure based on measurement reports of the UE. Change of a Primary Cell (PCell) and a Primary Secondary Cell (PSCell) via reconfiguration with sync (e.g., involving Layer-3 RRC message) involves high latency and more overhead than L1/L2 signaling (e.g., beam switch mobility). In addition, in operation on Frequency Range 2 (FR2), frequent Secondary Cell Group (SCG) changes will occur, which could also lead to high latency for UE-Network (NW) communication if L3 Handover is used. Therefore, in WID for NR mobility enhancements (e.g., [3] RP-212710 New Work Item Description (WID) on NR further mobility enhancements), an objective of the work item is to specify a mechanism and procedure (e.g., a L1/L2-triggered mobility procedure, or Layer 1/Layer2 Triggered Mobility (LTM) procedure) for dynamic switching mechanisms among serving cells, including Special Cell (SpCell) and/or Secondary Cell(s) (SCell(s)) based on L1/L2 signaling. The serving cells could include a target Cell of the LTM procedure and one or more Secondary Cells (to be added or released) in the LTM procedure. An LTM procedure could consist of Next Generation Node B (gNB) of the source Cell providing a first information and a second information. The first information could contain or indicate candidate cell information (e.g., candidate cell configuration) (via an RRC message). The first information could contain or indicate one or more RRC reconfiguration messages associated with one or more candidate cells (or candidate cell group(s)). For example, the first information could contain or indicate cell configuration and/or random access (Random Access Channel (RACH)) configurations for the one or more candidate cells. The first information could contain one or more RRCReconfiguration messages, each for a candidate (cell) configuration associated with a candidate cell. The second information may not be an RRC or L3 message (e.g., could contain a Physical Downlink Control Channel (PDCCH) and/or a Medium Access Control (MAC) Control Element CE)), and could indicate the UE to perform an LTM procedure to a candidate cell (group) (in the one or more candidate cells in the first information). The second information could be an LTM switch command or a Cell switch command (e.g., a Downlink Control Indicator (DCI) and/or a MAC CE). The candidate cell(s) could be target Cell(s) of the LTM procedure. Each of the one or more candidate cells could be associated with an identity or index (e.g., candidate index). The second information could indicate the candidate index of the candidate cell. The candidate cell(s) of the UE is not a serving cell of the UE. The candidate cell(s) of the UE is a candidate to be a serving cell (e.g., PCell or SpCell) of the UE.

For LTM, both RACH-based and RACH-less LTM will be supported. For a RACH-based LTM, the UE initiates/performs a random access procedure to a target Cell in an LTM procedure (in response to receiving a cell switch command to switch to the target cell).

For a RACH-less LTM, the UE may not initiate/perform a random access procedure to a target Cell in an LTM procedure in response to or after receiving a cell switch command to switch to the target Cell. A UE could determine whether to perform a random access procedure (to obtain a Timing Advance (TA)) to a target Cell in response to a Cell switch command (e.g., the second information) based on whether there's a valid TA associated with the target Cell (stored in the UE). The valid TA associated with the target Cell could be a TA associated with a candidate cell (that is stored in or maintained by the UE). The UE could perform a (early) TA acquisition to the target Cell (or a candidate cell) to obtain the TA (before initiating an LTM procedure). Alternatively, the UE could perform UE based TA measurement to obtain the TA of the target Cell (or a candidate cell). When the UE maintains or stores a TA associated with a candidate cell, the validity of the TA needs to be ensured and the TA may need to be updated or released/discard if or when the TA is not valid. In addition, due to storage capacity (e.g., the number of stored TAs in a list of stored TAs for candidate cell(s) is limited) or configuration limitation of the UE, the UE could store or maintain TAs for a maximum number of candidate cells. In order to maintain TAs while adding/updating the TAs for candidate cells, an issue could be raised regarding how to update or whether to notify the network regarding the storage condition of the TAs in order to have an aligned TA maintenance knowledge between the network and the UE.

With the present invention, methods and systems are introduced for handling stored TA and timer maintenance for candidate cells, as detailed below.
Handling of TA/Time Alignment Timer (TAT) for a candidate cell.
   Assume that the number of stored TAs and/or TATs for candidate cells is limited.
      For a stored TA for a candidate cell:
         How/when to clear the stored TA?
         Clear the stored TA when the corresponding TAT expires or not?
         Whether serving cell changes or UE state transition impact the stored TA?
         Whether/how to update the stored TA?
         How/when to replace the stored TA by a TA for another candidate cell?
         Which one to replace?
      For a running TAT for a candidate cell:
         How/when to stop the TAT?
         How/when to restart the TAT?
      Should the maximum number be reported to the network, e.g., as UE capability?
      Should the current number be reported to the network?
      Should the UE report to the network about which candidate cell(s) has (valid) stored TAs? e.g., UE-initiated or NW-requested.
   The number of stored TAs reaches the maximum and early TA PDCCH order is received.
   The number of stored TAs reaches the maximum and LTM is performed from a source Cell to a target Cell.
      Will the TA of the source cell be stored?

### Clear Stored TA

One concept of the present invention is that a UE could determine whether to clear or discard a (stored) TA associated with a candidate cell (of the UE). To clear or discard a stored TA for a candidate cell (of the UE), the UE could remove, clear, release, or discard the stored TA from a list (or a set) of stored TA(s) for candidate cell(s) (of the UE). The list (or the set) of stored TA(s) may not contain TA(s) for Serving Cell(s) (of the UE).

The UE could determine whether to clear/release the stored TA based on at least one of:
Status of a timer associated with the stored TA;
The UE performing an RRC re-establishment;
The UE entering RRC_IDLE or RRC_INACTIVE state;
Serving Cell change;
UE storage capacity of storing TA of cell(s); and/or
Remaining valid time of the stored TA

For example, for a UE with a stored TA associated with a candidate cell (of the UE), the UE could determine whether to clear/release/discard the stored TA based on status of a timer (associated with at least the (stored) TA associated with the candidate cell). For example, the UE could clear or discard the stored TA associated with the candidate cell when or in response to expiry/expiration of the timer. The timer could be a Time Alignment Timer (or TA timer or TAT) associated with at least the candidate cell. Additionally and/or alternatively, the timer could be associated with a Timing Advance Group (TAG) associated with at least the candidate cell. Additionally and/or alternatively, the UE could start or restart the timer when or in response to obtaining, storing, or updating the TA associated with the candidate cell. Value or length of the timer associated with different candidate cells (of the UE) could be configured (by the network) independently or could be the same (e.g., could not be different). The UE could keep or maintain a stored TA associated with a serving cell when or in response to expiry of a TAT associated with the serving cell.

For example, the UE could (re) start the timer in response to obtaining, storing, or updating the TA associated with the candidate cell or transmitting a report to the network. The report could contain or indicate (information related to) the TA and/or the candidate cell. Additionally and/or alternatively, the UE could (re) start the timer in response to initiation or completion of a (early) TA acquisition on the candidate cell (for obtaining the TA). The UE could (re) start the timer in response to receiving a PDCCH order from a network indicating initiation of the TA acquisition. The UE could stop the timer associated with the candidate cell in response to the UE clearing or discarding the stored TA associated with the candidate cell.

The UE could clear or discard the stored TA associated with the candidate cell when or in response to candidate (cell) reconfiguration associated with the candidate cell. The candidate (cell) reconfiguration could release or remove the candidate cell. Alternatively, the UE may not clear or discard (or may keep or maintain) the stored TA associated with the candidate cell when or in response to candidate (cell) reconfiguration associated with the candidate cell. The candidate (cell) reconfiguration may not release or remove the candidate cell. For another example, the UE could stop the timer in response to candidate (cell) reconfiguration associated with the candidate cell. The candidate (cell) reconfiguration could release or remove the candidate cell. Alternatively, the UE may not stop the timer in response to reconfiguration with sync or LTM switching SpCell to a candidate cell (of the UE).

A candidate (cell) reconfiguration associated with the candidate cell could be a release of a candidate cell configuration (associated with the candidate cell). Additionally and/or alternatively, a candidate (cell) reconfiguration associated with the candidate cell could be removing the candidate cell from a candidate cell list.

Alternatively, the UE may not clear or discard (or may keep or maintain) the stored TA associated with the candidate cell in response to the expiry of the timer. For example, the UE could store or keep or maintain the TA (as long as the UE has storing capacity to store the TA) after the timer expiration.

Additionally and/or alternatively, the UE could clear or discard the stored TA associated with the candidate cell in response to serving cell (e.g., PCell or SpCell) changes of the UE. For example, the UE could clear or discard the stored TA in response to a serving cell release. The candidate cell could be sharing or associated with a same TAG with the serving cell. The stored TA associated with the candidate cell could be a TAG or a TA associated with the serving cell. Alternatively, the UE may not clear or discard (or may keep or maintain) the stored TA associated with the candidate cell in response to a serving cell change or serving cell release.

The serving cell change could be in response to a reconfiguration with sync (e.g., received from network).

Additionally and/or alternatively, the UE could clear or discard the stored TA associated with the candidate cell in response to receiving an RRC message (e.g., MobilityFromNRCommand). For example, the UE could clear or discard the stored TA in response to a serving cell release. The candidate cell could be sharing or associated with a same TAG with the serving cell. The stored TA associated with the candidate cell could be a TAG or a TA associated with the serving cell. Alternatively, the UE may not clear or discard (or may keep or maintain) the stored TA associated with the candidate cell in response to receiving an RRC message (e.g., MobilityFromNRCommand).

Additionally and/or alternatively, the UE could clear or discard the stored TA associated with the candidate cell in response to receiving an RRC message (e.g., RRCReconfiguration) containing reconfiguration WithSync. For example, the UE could clear or discard the stored TA in response to a serving cell release. The candidate cell could be sharing or associated with a same TAG with the serving cell. The stored TA associated with the candidate cell could be a TAG or a TA associated with the serving cell. Alternatively, the UE may not clear or discard (or may keep or maintain) the stored TA associated with the candidate cell in response to receiving an RRC message (e.g., RRCReconfiguration) containing reconfiguration With Sync.

The serving cell change could be in response to an LTM procedure.

Additionally and/or alternatively, the UE could clear or discard the stored TA associated with the candidate cell in response to receiving a second information (e.g., a cell switch command) indicating or initiating an LTM procedure to (change PCell or SpCell to) a second candidate cell (of the UE). For example, the UE could clear or discard the stored TA in response to a serving cell release. The candidate cell could be sharing or associated with a same TAG with the serving cell. The stored TA associated with the candidate cell could be a TAG or a TA associated with the serving cell. Alternatively, the UE may not clear or discard (or may keep or maintain) the stored TA associated with the candidate cell in response to receiving a second information (e.g., a cell switch command) indicating an LTM procedure to a second candidate cell (of the UE). The second candidate cell could be the candidate cell associated with the stored TA. Alternatively, the second candidate cell could be different from the candidate cell associated with the stored TA.

The serving cell change could be in response to an RRC re-establishment.

Additionally and/or alternatively, the UE could clear or discard the stored TA associated with the candidate cell when performing RRC re-establishment. For example, the UE could clear or discard the stored TA in response to a serving cell release. The candidate cell could be sharing or associated with a same TAG with the serving cell. The stored TA associated with the candidate cell could be a TAG or a TA associated with the serving cell. Alternatively, the UE may not clear or discard (or may keep or maintain) the stored TA associated with the candidate cell when performing RRC re-establishment.

The serving cell change could be in response to a UE-initiated LTM (e.g., conditional LTM) or a conditional reconfiguration (e.g., conditional handover).

Additionally and/or alternatively, the UE could clear or discard the stored TA associated with the candidate cell when performing an LTM procedure initiated by the UE or a conditional reconfiguration. For example, the UE could clear or discard the stored TA in response to a serving cell release. The candidate cell could be sharing or associated with a same TAG with the serving cell. The stored TA associated with the candidate cell could be a TAG or a TA associated with the serving cell. Alternatively, the UE may not clear or discard (or may keep or maintain) the stored TA associated with the candidate cell when performing an LTM procedure initiated by the UE or a conditional reconfiguration.

Additionally and/or alternatively, the UE could clear or discard the stored TA associated with the candidate cell in response to completion of an LTM (or a handover, or reconfiguration with sync) to the candidate cell. In response to switching the SpCell of the UE to the candidate cell, the UE could clear or discard the store TA of the candidate cell (and apply the stored TA as a TA for SpCell or Primary Timing Advance Group (pTAG)). Additionally and/or alternatively, the UE could clear or discard a stored TA associated with a first candidate cell (of the UE) in response to a completion of an LTM or a reconfiguration with sync (handover) procedure to a second candidate cell (of the UE). Additionally and/or alternatively, the UE may not clear or discard (or may keep or maintain) a stored TA associated with a first candidate cell (of the UE) in response to a completion of an LTM or a reconfiguration with sync (handover) procedure to a second candidate cell (of the UE).

Additionally and/or alternatively, the UE could clear or discard the stored TA associated with the candidate cell in response to the UE entering (from RRC_CONNECTED to) RRC_INACTIVE state or RRC_IDLE state. Additionally and/or alternatively, the UE may not clear or discard (or may keep or maintain) the stored TA associated with the candidate cell in response to the UE entering (from RRC_CONNECTED to) RRC_INACTIVE state or RRC_IDLE state. The UE could keep or maintain a stored TA associated with a serving cell in response to the UE entering (from RRC_CONNECTED to) RRC_INACTIVE state or RRC_IDLE state.

Update TA: Update the Same TA or Replace the Old TA with New Candidate Cell TA

Additionally and/or alternatively, the UE could update or renew the stored TA associated with a candidate cell (of the UE). The UE could update or renew the stored TA associated with the candidate cell if or when the stored TA is invalid, or a timer associated with the TAT expires. The stored TA could be considered invalid if or when the UE is reconfigured with candidate cell configuration(s) or reconfigured with LTM configuration(s). For example, the UE could trigger or initiate a TA acquisition procedure to the candidate cell in response to expiry of the timer associated with the TA associated with the candidate cell. The TA acquisition procedure could include transmitting a random access preamble to the candidate cell. The TA acquisition procedure could include receiving a message or signaling (e.g., random access response, or MAC CE or DCI) indicating TA associated with the candidate cell. Additionally and/or alternatively, the TA acquisition procedure could include applying a new TA value to the stored TA. The new TA value could be derived from a serving cell TA or a TAG (by the UE). The new TA value could be derived from a reconfigured (LTM) candidate cell configuration or a reconfigured TAG.

Replace TA w/Another Candidate Cell's TA
Determine which TA to Discard/be Replaced

Additionally and/or alternatively, the UE could discard or clear a first stored TA associated with a first candidate cell (of the UE) in response to adding or storing a second TA associated with a second candidate cell (of the UE). The UE could determine the first stored TA among all stored TA(s) associated with (one or more) candidate cell(s) (of the UE) to discard or clear based on at least an id or index associated with the TA. For example, the first candidate cell could be associated with a candidate cell configuration with the lowest (or highest) candidate cell id or index (e.g., LTM candidate id). Additionally and/or alternatively, the UE could determine which TA among all stored TA(s) associated with (one or more) candidate cell(s) (of the UE) to discard or clear based on at least status of a timer associated with the TA(s). For example, the UE could discard or clear a first TA in response to adding or storing a second TA based on at least a timer associated with the first TA has expired. Additionally and/or alternatively, the UE could determine the first stored TA among all stored TA(s) (of the list or the set of stored TA(s)) associated with (one or more) candidate cell(s) (of the UE) to discard or clear based on at least validity of the stored TA(s).

Additionally and/or alternatively, the UE could determine the first stored TA among all stored TA(s) (of the list or the set of stored TA(s)) associated with (one or more) candidate cell(s) (of the UE) to discard or clear based on at least whether each of the stored TA(s) is valid (or not).

Additionally and/or alternatively, the UE could determine the first stored TA among all stored TA(s) associated with (one or more) candidate cell(s) (of the UE) to discard or clear based on at least an id or index associated with the candidate cell (of the UE). For example, the UE could discard or clear a first TA associated with a first candidate cell (of the UE) in response to adding or storing a second TA, wherein the first candidate cell is associated with a lowest id (e.g., candidate configuration id) among candidate cell(s) (of the UE) with (valid or invalid) stored TA(s).

Additionally and/or alternatively, the UE could determine the first stored TA among all stored TA(s) associated with (one or more) candidate cell(s) (of the UE) to discard or clear based on at least remaining valid time of each of the stored TA(s). Additionally and/or alternatively, the UE could discard a first TA (among all stored TA(s) associated with candidate cell(s)) with the shortest remaining valid time (e.g., timer associated with the first TA is the closest to timer expiry) in response to adding or storing a second TA.

Additionally and/or alternatively, the UE could determine the first stored TA among all stored TA(s) associated with (one or more) candidate cell(s) (of the UE) to discard or clear based on at least (absolute) value of each of the stored TA(s). Additionally and/or alternatively, the UE could discard a first TA (among all stored TA(s) associated with candidate cell(s)) with the largest (absolute) TA value (e.g., candidate cell associated with the first TA is the farthest from the UE) in response to adding or storing a second TA.

Additionally and/or alternatively, the UE could discard or clear the (very) first TA that was stored in the list (or the set) of stored TA(s) (in response to adding or storing a second TA associated with a second candidate cell (of the UE)).

Additionally and/or alternatively, the UE could determine the first stored TA among all stored TA(s) associated with (one or more) candidate cell(s) (of the UE) to discard or clear based on at least whether each of the stored TA(s) has been used or applied (to a serving cell). For example, the UE could discard or clear a stored TA that was used the least.

The UE may not discard or clear (or may keep or maintain) (any) TA associated with candidate cell(s) (of the UE) in response to adding or storing an (additional) TA if or when the storage capacity (e.g., a list (or a set) of stored TA for candidate cell(s)) of the UE can accommodate all stored TAs (and the (additional) TA). The UE could discard or clear a TA associated with a candidate cell (of the UE) in response to adding or storing an (additional) TA if or when the storage capacity (e.g., a list (or a set) of stored TAs for candidate cell(s)) of the UE cannot accommodate all stored TAs (and the additional TA).

An example is shown in FIG. 13, wherein the UE could store/maintain a maximum number of stored TA (e.g., 2). The UE stores a first TA, TA1, for candidate cell 1, and a second TA, TA2, for candidate cell 2 (before timing t1). The UE obtains a third TA for candidate cell 3 (e.g., via TA acquisition procedure) at timing t1. The UE could determine to discard/clear TA1 based on candidate cell 1 being associated with the lowest LTM candidate id. The UE stores TA3 for candidate cell 3 and (keeps) TA2 for candidate cell 2.

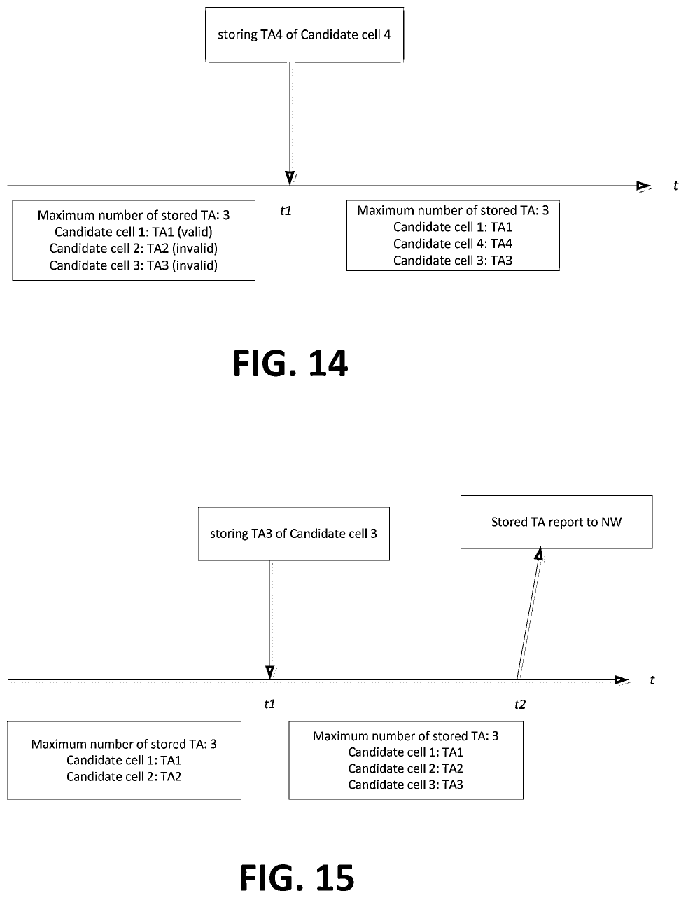

Another example is shown in FIG. 14. The UE stores (a maximum of) 3 TAs, TA1, TA2, and TA3 for candidate cell 1, 2 and 3, respectively (before timing t1). The TA1 is valid and the TA2 and TA3 are invalid (e.g., Timer expired or candidate cell or associated serving cells have been reconfigured). The UE receives or obtains TA4 associated with candidate cell 4. The UE could determine to remove or clear or discard TA2 and store TA4 for candidate cell 4 (e.g., based on TA2 being associated with candidate cell with the lowest LTM candidate configuration id among candidate cells with invalid (or valid) TA stored).

For another example, (when the storage capacity cannot accommodate the additional TA,) the UE could (first) determine whether there are invalid stored TAs among all stored TAs. When there are (one or more) invalid stored TAs, the UE discards or clears one of the invalid stored TAs (e.g., that is used the least or the (very) first invalid TA that was stored in the list (or the set) among the (one or more) invalid stored TA(s)). Additionally and/or alternatively, when there are no invalid stored TAs, the UE discards or clears one of all stored TAs (e.g., that is used the least or the (very) first invalid TA that was stored in the list (or the set) among the (one or more) invalid stored TA(s)).

Not Obtaining TA when Maximum (of the Storage Capacity) is Reached

Additionally and/or alternatively, the UE may not perform TA acquisition to a candidate cell (of the UE) if or when the number of stored TAs of the UE has reached the maximum number of stored TAs. The maximum number of stored TAs could be the number of TAs for candidate cells the UE could store or maintain at a (same) time.

For example, the UE could determine whether to perform TA acquisition in response to receiving a PDCCH order from a NW for TA acquisition on a candidate cell (of the UE) based on at least whether the number of stored TAs has reached the maximum number. The UE may not perform TA acquisition if the number of stored TAs has reached the maximum. The UE could perform TA acquisition on the candidate cell if the number of stored TAs has not reached the maximum.

Alternatively, the UE may not initiate (by itself) a TA acquisition on a candidate cell (of the UE) if or when the number of stored TAs has reached the maximum. The UE could initiate TA acquisition (ordered by the network) if or when the number of stored TAs has reached the maximum. The UE may not store or has not obtained TA for the candidate cell before receiving the PDCCH order or performing the TA acquisition.

UE Store Previous Left Serving Cell/TAG//Stores Source Cell TA when Triggering/Initiating LTM

Additionally and/or alternatively, the UE could store or keep or maintain a TA associated with a source cell when initiating or triggering an LTM procedure to (switch from the source cell to) a candidate cell (of the UE). The source cell could be one of the candidate cells of the UE. The UE may not store or keep or maintain (or may clear or discard) the TA associated with the source cell if the number of stored TAs has reached the maximum. Alternatively, the UE could store or keep or maintain the TA associated with the source cell after applying the TA associated with the candidate cell. The UE could replace (e.g., discard or clear) a stored TA associated with the candidate cell (e.g., target cell of the LTM) with the TA associated with the source cell. When the number of stored TAs has reached the maximum, the UE could determine a stored

TA associated with a candidate cell (of the UE) to discard or clear (and store the TA associated with the source cell) (e.g., based on methods described above).

Additionally and/or alternatively, the UE could store or keep or maintain (TA(s) of) one or more TAGs associated with one or more serving cells or the source cell when initiating or triggering an LTM procedure to a candidate cell (of the UE). The UE may not store or keep or maintain (or may clear or discard) the TA associated with the source cell if the number of stored TAs has reached the maximum.

To store a TA for a candidate/source cell, the UE could add/keep/maintain the TA in a list (or a set) of stored TAs for candidate cell(s).

### Indicate Replaced TA or Updated TA or Currently Stored TA to NW

Another concept of the present invention is that a UE could transmit a report to indicate information associated with stored/maintained/valid TA(s) associated with one or more candidate cell(s) (of the UE) and/or information associated with one or more candidate cell(s) (of the UE) with stored/maintained/valid TA(s) to a network. The report could be a TA report or a stored TA status report. The report could be a measurement report.

The UE could trigger to transmit the report in response to a change or update in the stored TA(s) of candidate cell(s) (of the UE) or change or update of the list (or the set) of stored TAs of candidate cells (of the UE). For example, the UE could transmit a report to the network in response to obtaining or storing a (new) TA associated with a candidate cell (of the UE). A candidate cell (of the UE) or the (new) TA associated with the candidate cell (of the UE) may not be reported or indicated to the network (in a previous report). For another example, the UE could (trigger to) transmit a report to the network in response to clearing or discarding a stored TA associated with a candidate cell (of the UE). For another example, the UE could (trigger to) transmit a report to the network in response to a stored TA associated with a candidate cell (of the UE) becoming or being considered as invalid. For another example, the UE could (trigger to) transmit a report to the network in response to expiry of a TAT associated with a candidate cell (of the UE). For another example, the UE could (trigger to) transmit a report to the network in response to clearing a stored TA associated with a candidate cell (of the UE). For another example, the UE could (trigger to) transmit a report to the network in response to replacing a stored TA associated with a candidate cell (of the UE).

Additionally and/or alternatively, the UE could trigger the report indicating stored (and/or valid) TA(s) in response to (reception of) a signaling indicated by the network. The UE could transmit the report in response to receiving the signaling (e.g., a DCI or an RRC message or a MAC CE) from the network. The signaling could indicate a request for the report.

Additionally and/or alternatively, the UE could trigger to transmit the report based on a periodicity or a timer. The timer could be a report timer. The UE could trigger the report if or when the timer expires. The UE could start or restart the timer when the UE triggers or transmits the report to the network.

An example is shown in FIG. 15. The UE stores TA1 and TA2 for candidate cell 1 and candidate cell 2 before timing t1. At timing t1, the UE obtains/stores TA3 of candidate cell 3. In response to the obtaining or storing of the TA3, the UE could trigger to transmit a report indicating TA associated with one or more candidate cells to the NW.

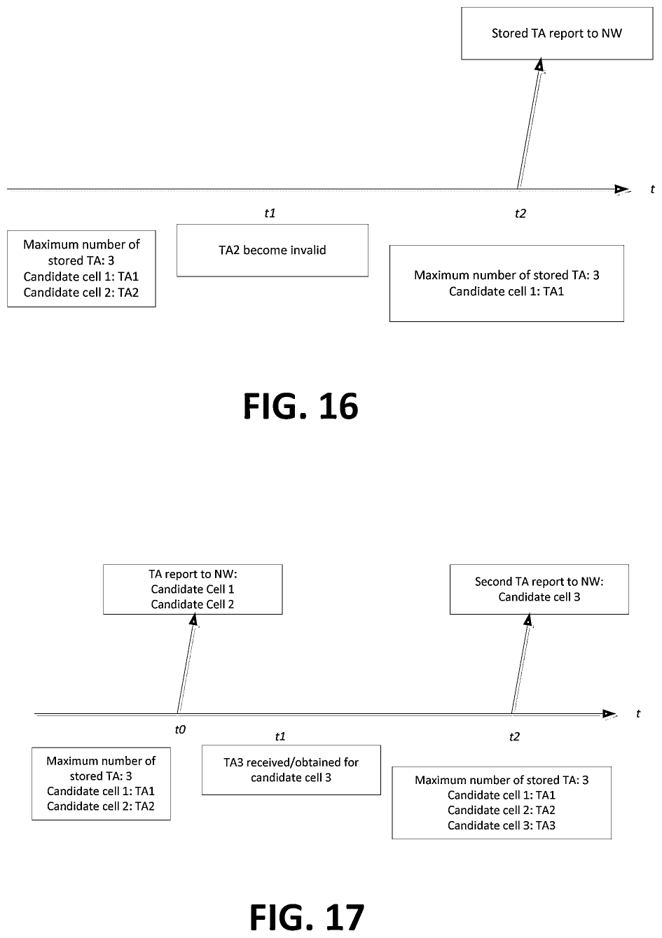

Another example is shown in FIG. 16. The UE stores TA1 and TA2 for candidate cells 1 and 2. At timing t1, the TA2 becomes invalid (e.g., timer expiry or UE reconfiguration). The UE could discard or clear the stored TA2 in response to considering the TA2 as invalid. In response to discarding/clearing the TA2, the UE could trigger to transmit a report to the network (indicating the change of the stored TA(s)).

### Content of the Report

The report could contain or indicate candidate cell(s) (of the UE) with (valid) stored TA(s). Additionally and/or alternatively, the report could contain or indicate the number of (valid) stored TAs associated with candidate cells stored in the UE. Additionally and/or alternatively, the report could contain or indicate the number of candidate cells (of the UE) associated with (valid) stored TA(s) stored in the UE. The report could contain or indicate candidate cell(s) (of the UE) of which stored TA is removed/cleared. The report could contain or indicate candidate cell(s) (of the UE) without (valid) stored TA.

The report could contain or indicate (valid) stored TA(s) associated with candidate cell(s) of the UE. Alternatively, the report may not contain or indicate (valid) stored TA(s) associated with candidate cell(s) of the UE.

The report could contain a flag indicating whether the report is triggered for indicating added TA or cleared TA for candidate cell(s) (of the UE). Additionally and/or alternatively, the flag could be indicated (individually) for each candidate id or candidate cell (of the UE). Additionally and/or alternatively, the report could contain a field indicating candidate configuration (e.g., LTM candidate id) associated with candidate cell(s) (of the UE) of which TA is stored or removed or cleared. Additionally and/or alternatively, the report could contain a bitmap indicating candidate configuration associated with candidate cell(s) (of the UE) of which TA is stored or valid or removed or cleared. Each bit of the bitmap could correspond a candidate cell (of the UE). Each bit of the bitmap could indicate whether a candidate cell (corresponding to the bit) (of the UE) has a (valid) stored TA or not. The report could contain a bit to indicate whether a candidate cell (of the UE) has a (valid) stored TA or not.

The report could contain or indicate measurement result(s) of a candidate cell (of the UE). The measurement result(s) could be associated with Synchronization Signal Block(s) (SSB(s)) or Channel State Information Reference Signal(s) (CSI-RS(s)) or (activated) Transmission Configuration Indicator (TCI) state(s) of the candidate cell (e.g., L1 measurements). The measurement result(s) could be Reference Signal Received Power (RSRP) (e.g., L1 or L3 RSRP measurement). The report could contain the SSB(s) or the CSI-RS(s) or the (activated) TCI state(s) associated with the measurement result(s).

The report could be a MAC CE or an RRC message.

### Indicate Newly Added TA or all Stored TAs

The report could indicate (all) candidate cell(s) (of the UE) of which TA is stored (and/or valid) in the UE. Alternatively, the report could indicate one or more candidate cell(s) (of the UE) of which TA is added or cleared (since the latest report). The report could report the delta, or the difference of stored TA status compared to the last time a report was transmitted.

Another example is shown in FIG. 17. At timing t0, the UE reports to the NW a TA report indicating the UE stores TA (TA1, TA2) for candidate cell 1 and candidate cell2. At timing t1, the UE obtained/maintains TA3 for candidate cell3. The UE could trigger to transmit a second report to the NW at timing t2. The UE could report all candidate cells (e.g., candidate cell 1, 2, 3) to the NW in the second report. Alternatively, the UE could report candidate cell 3 to the NW in the second report (due to the TA storage status of candidate cell 3 having been changed since the last time a report was transmitted).

### Indicate UE Storage Capacity to NW

### Indicate Currently Stored Number

Additionally and/or alternatively, the report could contain or indicate storage capacity of the UE (e.g., the maximum number of stored TAs in the list (or the set) of stored TA(s)) to the network. The storage capacity could be the maximum number of TAs associated with candidate cells that can be stored/maintained by the UE. The storage capacity could be the maximum number of TAs (or TA value(s)) (associated with candidate cell(s) of the UE) that could be memorized by the UE. Alternatively, the storage capacity of the UE may not be indicated by the report. The storage capacity could be indicated in a different message other than the report (e.g., the different message could be an RRC message). The storage capacity could be a UE capability of storing TA(s) (for candidate cells).

Additionally and/or alternatively, the report could contain or indicate the number of (valid) TAs (associated with candidate cell(s) of the UE) currently stored by the UE. Additionally and/or alternatively, the report could contain or indicate the TA associated with each reported candidate cell stored by the UE.

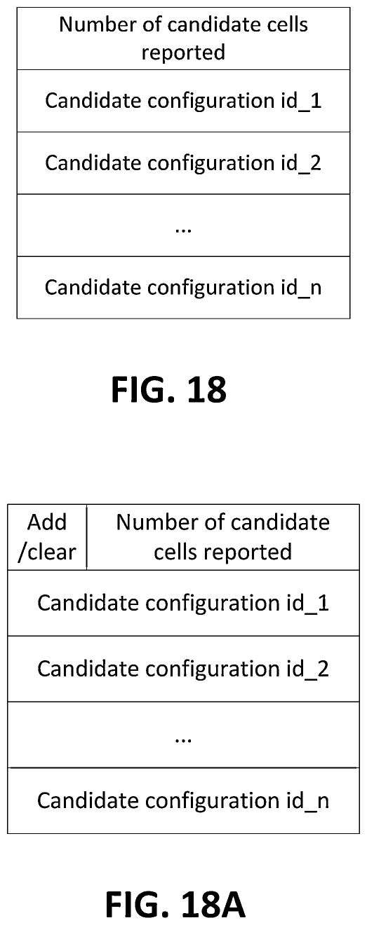

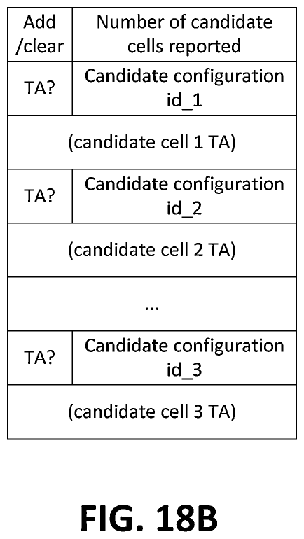

An example is shown in FIG. 18. The report could indicate one or more candidate configuration ids associated with one or more candidate cells. The report could indicate the number of candidate cells reported in the report.

Another example is shown in FIG. 18A. The report could indicate a field/flag indicating whether the report indicates the UE adds or clears stored TAs for the indicated configurations/associated candidate cells. Another example is shown in FIG. 18B. The report could indicate whether the report includes a TA value for each candidate cells reported.

### Network Determines Whether to Send PDCCH Order/TA in CSC Based on UE Report/Update on the TA.

Additionally and/or alternatively, the network could determine whether to initiate a TA acquisition on a candidate cell for a UE based on at least the report. The network could initiate a TA acquisition for a UE on a candidate cell if or when the UE does not store a TA for the candidate cell or the stored TA is invalid or not aligned with the network.

Additionally and/or alternatively, the network could determine whether to indicate a TA in a second information to the UE in an LTM procedure to a candidate cell (e.g., in a cell switch command) based on whether the UE has a valid stored TA of the candidate cell.

For the embodiments, examples, and concepts detailed above and herein, the following aspects and embodiments are possible.

A TA associated with a candidate cell could be provided/indicated by the network via the first information (e.g., candidate cell configuration). The TA associated with the candidate cell could be obtained/stored by the UE before receiving an LTM cell switch command indicating switching to the candidate cell. Additionally and/or alternatively, The TA could be provided/indicated by the network via the second information (e.g., cell switch command). Alternatively, the (stored) TA associated with the candidate cell may not be provided/indicated by the network (via the second information nor via a cell switch command). Additionally and/or alternatively, the UE could perform TA acquisition for a candidate cell to obtain the TA associated with the candidate cell before initiating an LTM procedure (e.g., before receiving a second information or a cell switch command). The TA acquisition (procedure) for a candidate cell could contain or include the network transmitting a PDCCH order (or PDCCH order-like) message to the UE. The message could indicate the UE to initiate the TA acquisition procedure or to obtain a TA associated with the candidate cell. The TA acquisition (procedure) for a candidate cell could contain or include a UE transmitting a (random access) preamble to the candidate cell. The TA acquisition for the candidate cell could contain or include the UE receiving a message (or signaling) (e.g., a Random Access Response (RAR), or RAR-like message, or MAC CE, or DCI) containing or indicating the TA associated with the candidate cell.

Additionally and/or alternatively, the UE could obtain or derive the TA associated with a candidate cell.

Additionally and/or alternatively, the UE could obtain or derive the TA associated with a candidate cell by storing a TA of a TAG associated with a (previous) Serving Cell. The (previous) Serving Cell could be the candidate cell or share a same TA as the candidate cell.

The TA could be a timing difference between uplink and downlink of a cell. The TA could be a TA value. The TA could be an N_{TA}. The TA could be a TAG id. The TA could be a Timing Advance Command (TAC).

To discard or clear a TA associated with a candidate cell, the UE could consider the TA to be invalid and/or the UE may not apply the TA on the candidate cell in response to performing an LTM procedure on the candidate cell.

A candidate cell could be a (Primary) cell in a candidate cell group configuration.

The candidate cell group configuration could be an RRC reconfiguration message.

A UE could perform a TA acquisition indicated by the network or initiated by the UE (itself) (e.g., for a candidate cell). A TA acquisition could be an early TA acquisition (e.g., an early Uplink (UL) synchronization) for a candidate cell before receiving a cell switch command for an LTM procedure. The TA acquisition could contain a RAR-based RACH or a RAR-less RACH. The RAR could indicate TA information (e.g., TA or TAC) associated with the candidate cell.

A RAR-less RACH could contain a random access response. The random access response may not contain a RAR. The RAR could be a MAC payload of a Random Access Response. The RAR-less RACH could contain a MAC subheader (only) of a Random Access Response.

The UE could be configured with RAR-less RACH for candidate cells. A RAR-less RACH could contain a RAR-less TA acquisition mechanism.

A serving cell/candidate cell configuration could be/include a RACH configuration for random access procedure on a candidate cell. The RACH configuration could indicate search space id and/or RACH occasion and/or preamble index.

A TA information associated with a candidate cell could be a TA command (Timing advance command) or an N_{TA} or a TAG associated with the candidate cell.

TA information of a candidate cell could be a timing difference between uplink and downlink associated with the candidate cell.

The PDCCH order initiating a random access procedure on a candidate cell could contain or indicate a

Bandwidth Part (BWP) (of a candidate cell).

The PDCCH order initiating a random access procedure on a candidate cell could contain or indicate a Cell/candidate index (of a candidate cell or a candidate cell configuration).

The PDCCH order initiating a random access procedure on a candidate cell could contain or indicate a RACH configuration (associated with a candidate cell or a candidate cell configuration).

The first PDCCH occasion (at which the UE starts the window) could be a first PDCCH occasion associated with Cell Radio Network Temporary Identifier (C-RNTI) or Random Access (RA)-Radio Network Temporary Identifier (RNTI) (after preamble transmission or after an offset after the preamble transmission). The first PDCCH occasion could be a first PDCCH occasion associated with a (Type-1) common search space or a UE-specific search space.

The L1/L2-triggered mobility (LTM) could be an intra-Distributed Unit (DU) LTM. Alternatively, the LTM could be an inter-DU or inter-Centralized Unit (CU) LTM.

The LTM could comprise the network transmitting a first information and a second information to the UE. The first information could be an RRC message indicating one or more candidate cells (or cell group or one or more RRC reconfigurations indicating candidate configuration). The first information could contain one or more Cellgroupconfig(s) or one or more RRCReconfiguration messages. The second information could be an L1 or L2 signaling and/or a cell switch command (e.g., PDCCH and/or MAC CE). The UE could initiate an LTM or start Cell switching (to one or more candidate cell(s)) in response to the second information.

The first information could contain RACH configuration and/or Cell configuration for the one or more candidate cells. The network could indicate, in a PDCCH order for TA acquisition for candidate cells, the RACH configurations for corresponding candidate cells.

A candidate cell list could contain a list of candidate cell(s) (e.g., a list of candidate cell configurations indicating a list of candidate cells).

The candidate cell configuration could be a (part of) RRC reconfiguration message.

The RRC message could be an RRCReconfiguration.

The UE could consider the LTM to be successfully completed when receiving an acknowledgement from a network (e.g., target gNB). The acknowledgment could be in response to a complete message associated with the LTM transmitted by the UE. Additionally and/or alternatively, the UE could consider the LTM to be successfully completed when a random access procedure associated with (or initiated for the LTM) is successfully completed.

The UE could apply the stored (and/or valid) TA associated with the candidate cell to the candidate cell during or at the beginning of an LTM procedure to the candidate cell.

Any combination of the above or herein concepts or teachings can be jointly combined, in whole or in part, or formed to a new embodiment. The disclosed details and embodiments can be used to solve at least (but not limited to) the issues mentioned above and herein.

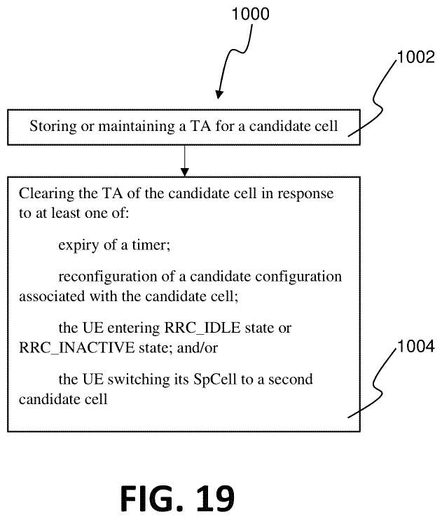

Referring to FIG. 19, with this and other concepts, systems, and methods of the present invention, a method 1000 for a UE in a wireless communication system comprises storing or maintaining a TA for a candidate cell (step 1002), and clearing the TA of the candidate cell in response to at least one of: expiry of a timer; reconfiguration of a candidate configuration associated with the candidate cell; the UE entering RRC_IDLE state or RRC_INACTIVE state; and/or the UE switching its SpCell to a second candidate cell (step 1004).

In various embodiments, the candidate cell is associated with an LTM configuration.

In various embodiments, the UE starts the timer in response to obtaining the TA of the candidate cell.

In various embodiments, the UE starts the timer in response to transmitting a report to a network indicating the TA.

In various embodiments, the UE starts the timer in response to receiving a PDCCH signaling from a network indicating a (early) TA acquisition procedure to obtain the TA for the candidate cell.

In various embodiments, the UE starts the timer in response to reconfiguration of a candidate configuration associated with the candidate cell.

In various embodiments, the UE stops the timer in response to initiation or completion of an LTM procedure to the candidate cell.

In various embodiments, the UE stops the timer in response to initiation or completion of an LTM procedure to the second candidate cell.

In various embodiments, the UE stops the timer in response to the TA becoming invalid.

In various embodiments, the UE clears the TA by removing the TA from a list (or a set) of stored TAs for candidate cells.

In various embodiments, the candidate cell is not a serving cell.

In various embodiments, the UE does not clear the TA in response to MAC reset or in response to initiation of an LTM procedure.

In various embodiments, the TA is N_{TA} or a TAG.

In various embodiments, the UE clears the TA by considering the TA as invalid.

In various embodiments, the PDCCH signalling is a PDCCH order.

In various embodiments, the candidate configuration is an L1/L2-triggered mobility (LTM) candidate configuration.

In various embodiments, the candidate configuration is an RRC configuration including or being associated with a configuration of the candidate cell.

Referring back to FIGS. 3 and 4, in one or more embodiments from the perspective of a UE, the device 300 includes a program code 312 stored in memory 310 of the transmitter. The CPU 308 could execute program code 312 to: (i) store or maintain a TA for a candidate cell; (ii) clear the TA of the candidate cell in response to at least one of: expiry of a timer; reconfiguration of a candidate configuration associated with the candidate cell; the UE entering RRC_IDLE state or RRC_INACTIVE state; and/or the UE switches its SpCell to a second candidate cell. Moreover, the CPU 308 can execute the program code 312 to perform all of the described actions, steps, and methods described above, below, or otherwise herein.

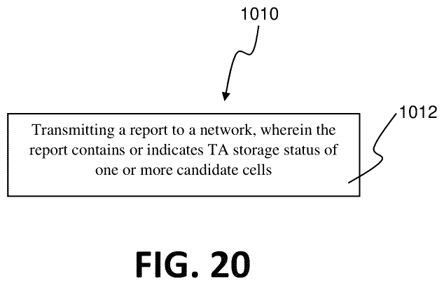

Referring to FIG. 20, with this and other concepts, systems, and methods of the present invention, a method 1010 for a UE in a wireless communication system comprises transmitting a report to a network, wherein the report contains or indicates TA storage status of one or more candidate cells (step 1012).

In various embodiments, the report is a MAC CE or an RRC message.

In various embodiments, the report indicates one or more ids associated with the one or more candidate cells.

In various embodiments, the report indicates a bitmap indicating the one or more candidate cells.

In various embodiments, the report indicates whether a TA is stored, or a stored TA is removed or cleared for the one or more candidate cells.

In various embodiments, the report indicates TA values for the one or more candidate cells.

In various embodiments, the UE triggers to transmit the report in response to obtaining or clearing a stored TA for at least one candidate cell.

In various embodiments, the UE triggers to transmit the report in response to replacing a stored TA or updating a stored TA value for at least one candidate cell.

In various embodiments, the UE triggers to transmit the report in response to expiry of a timer.

In various embodiments, the UE triggers to transmit the report in response to receiving a PDCCH signalling from the network.

In various embodiments, the UE triggers to transmit the report in response to invalidity of a stored TA associated with a candidate cell.

In various embodiments, the TA storage is a list (or a set) of stored TA for the one or more candidate cells.

In various embodiments, the PDCCH signalling is a PDCCH order.

In various embodiments, the candidate configuration is a L1/L2-triggered mobility (LTM) candidate configuration.

In various embodiments, the candidate configuration is an RRC configuration including or being associated with a configuration of the candidate cell.

Referring back to FIGS. 3 and 4, in one or more embodiments from the perspective of a UE, the device 300 includes a program code 312 stored in memory 310 of the transmitter. The CPU 308 could execute program code 312 to: (i) transmit a report to a network, wherein the report contains or indicates TA storage status of one or more candidate cells. Moreover, the CPU 308 can execute the program code 312 to perform all of the described actions, steps, and methods described above, below, or otherwise herein.

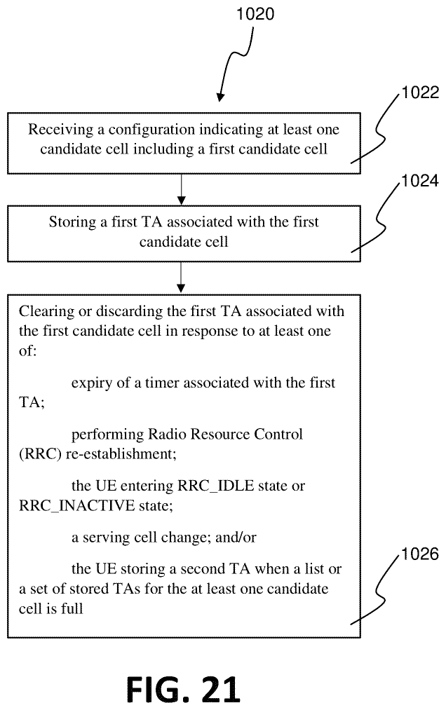

Referring to FIG. 21, with this and other concepts, systems, and methods of the present invention, a method 1020 for a UE in a wireless communication system comprises receiving a configuration indicating at least one candidate cell including a first candidate cell (step 1022), storing a first TA associated with the first candidate cell (step 1024), and clearing or discarding the first TA associated with the first candidate cell in response to at least one of: expiry of a timer associated with the first TA; performing RRC re-establishment; the UE entering RRC_IDLE state or RRC_INACTIVE state; a serving cell change; and/or the UE storing a second TA when a list or a set of stored TAs for the at least one candidate cell is full (step 1026).

In various embodiments, the UE obtains the first TA by receiving a message or signaling indicating the first TA.

In various embodiments, the UE obtains the first TA by UE based TA measurement.

In various embodiments, the UE starts or restarts the timer in response to obtaining or updating the first TA.

In various embodiments, the serving cell change is performed in response to a reconfiguration with sync or an LTM procedure.

In various embodiments, the UE stores a third TA associated with a source (serving) cell (of an LTM procedure) when initiating the LTM procedure to a second candidate cell.

In various embodiments, the UE clears or discards the first TA based on an ID associated with the first TA, an ID associated with the first candidate cell, or a remaining valid time of the first TA.

In various embodiments, the UE clears or discards the first TA based on: an ID associated with the first TA is lowest among IDs of stored (and/or valid) TAs associated with the at least one candidate cell, an ID associated with the first candidate cell is lowest among IDs of the at least one candidate cell with stored (and/or valid) TAs, a remaining valid time of the first TA is shortest among the at least one candidate cell with stored (and/or valid) TAs, the first TA is a very first TA stored in the list or the set of stored TAs, or the first TA is invalid.

Referring back to FIGS. 3 and 4, in one or more embodiments from the perspective of a UE, the device 300 includes a program code 312 stored in memory 310 of the transmitter. The CPU 308 could execute program code 312 to: (i) receive a configuration indicating at least one candidate cell including a first candidate cell; (ii) store a first TA associated with the first candidate cell; and (iii) clear or discard the first TA associated with the first candidate cell in response to at least one of: expiry of a timer associated with the first TA; performing RRC re-establishment; the UE enters RRC_IDLE state or RRC_INACTIVE state; a serving cell change; and/or the UE stores a second TA when a list or a set of stored TAs for the at least one candidate cell is full. Moreover, the CPU 308 can execute the program code 312 to perform all of the described actions, steps, and methods described above, below, or otherwise herein.

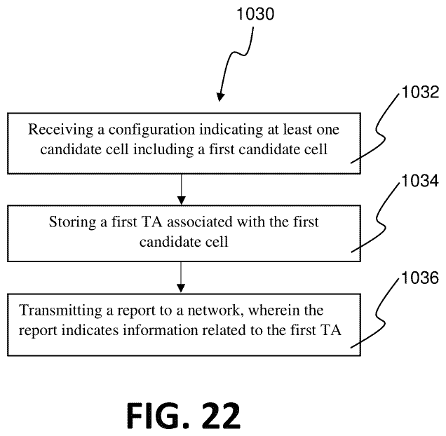

Referring to FIG. 22, with this and other concepts, systems, and methods of the present invention, a method 1030 for a UE in a wireless communication system comprises receiving a configuration indicating at least one candidate cell including a first candidate cell (step 1032), storing a first TA associated with the first candidate cell (step 1034), and transmitting a report to a network, wherein the report indicates information related to the first TA (step 1036).

In various embodiments, the UE transmits the report in response to change of a list or a set of stored TAs for the at least one candidate cell or in response to a signaling indicated by the network.

In various embodiments, the information indicates at least one of: a candidate cell with a stored (and/or valid) TA, the first TA, a number of stored (and/or valid) TAs for the at least one candidate cell, or a maximum number of stored TAs for the at least one candidate cell.

In various embodiments, the information includes at least one of: a bitmap indicating candidate configuration associated with the at least one candidate cell of which TA is stored and/or is valid, or a bit to indicate whether the first candidate cell has a stored (and/or valid) TA (or not).

In various embodiments, the UE transmits a maximum number of stored TAs for the at least one candidate cell via a different message than the report.

In various embodiments, the UE obtains the first TA by receiving a message or signaling indicating the first TA.

In various embodiments, the UE obtains the first TA by UE based TA measurement.

Referring back to FIGS. 3 and 4, in one or more embodiments from the perspective of a UE, the device 300 includes a program code 312 stored in memory 310 of the transmitter. The CPU 308 could execute program code 312 to: (i) receive a configuration indicating at least one candidate cell including a first candidate cell; (ii) store a first TA associated with the first candidate cell; and (iii) transmit a report to a network, wherein the report indicates information related to the first TA. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
receiving a configuration indicating at least one candidate cell including a first candidate cell;
storing a first Timing Advance (TA) associated with the first candidate cell; and
clearing or discarding the first TA associated with the first candidate cell in response to at least one of:
expiry of a timer associated with the first TA;
performing Radio Resource Control (RRC) re-establishment;
the UE entering RRC_IDLE state or RRC_INACTIVE state;
a serving cell change; and/or
the UE storing a second TA when a list or a set of stored TAs for the at least one candidate cell is full.

2. The method of claim 1, wherein the UE obtains the first TA by receiving a message or signaling indicating the first TA, or by UE based TA measurement.

3. The method of claim 1, wherein the UE starts or restarts the timer in response to obtaining or updating the first TA.

4. The method of claim 1, wherein the serving cell change is performed in response to a reconfiguration with sync or a L1/L2 Triggered Mobility (LTM) procedure.

5. The method of claim 1, wherein the UE stores a third TA associated with a source cell when initiating an LTM procedure to a second candidate cell.

6. The method of claim 1, wherein the UE clears or discards the first TA based on an Identity (ID) associated with the first TA, an ID associated with the first candidate cell, or a remaining valid time of the first TA.

7. The method of claim 1, wherein the UE clears or discards the first TA based on:
an ID associated with the first TA is lowest among IDs of stored and/or valid TAs associated with the at least one candidate cell,
an ID associated with the first candidate cell is lowest among IDs of the at least one candidate cell with stored and/or valid TAs,
a remaining valid time of the first TA is shortest among the at least one candidate cell with stored and/or valid TAs,
the first TA is a very first TA stored in the list or the set of stored TAs, or
the first TA is invalid.

8. A method of a User Equipment (UE), comprising:
receiving a configuration indicating at least one candidate cell including a first candidate cell;
storing a first Timing Advance (TA) associated with the first candidate cell; and
transmitting a report to a network, wherein the report indicates information related to the first TA.

9. The method of claim 8, wherein the UE transmits the report in response to change of a list or a set of stored TAs for the at least one candidate cell or in response to a signaling indicated by the network.

10. The method of claim 8, wherein the information indicates at least one of: a candidate cell with a stored and/or valid TA, the first TA, a number of stored and/or valid TAs for the at least one candidate cell, or a maximum number of stored TAs for the at least one candidate cell.

11. The method of claim 8, wherein the information includes at least one of:
a bitmap indicating candidate configuration associated with the at least one candidate cell of which TA is stored and/or is valid,
or a bit to indicate whether the first candidate cell has a stored and/or valid TA.

12. The method of claim 8, wherein the UE transmits a maximum number of stored TAs for the at least one candidate cell via a different message than the report.

13. The method of claim 8, wherein the UE obtains the first TA by receiving a message or signaling indicating the first TA, or by UE based TA measurement.

14. A User Equipment (UE), comprising:
a memory; and
a processor operatively coupled to the memory, wherein the processor is configured to execute program code to:
receive a configuration indicating at least one candidate cell including a first candidate cell;
store a first Timing Advance (TA) associated with the first candidate cell; and
clear or discard the first TA associated with the first candidate cell in response to at least one of:
expiry of a timer associated with the first TA;
performing Radio Resource Control (RRC) re-establishment;
the UE entering RRC_IDLE state or RRC_INACTIVE state;
a serving cell change; and/or
the UE storing a second TA when a list or a set of stored TAs for the at least one candidate cell is full.

15. The UE of claim 14, wherein the UE obtains the first TA by receiving a message or signaling indicating the first TA, or by UE based TA measurement.

16. The UE of claim 14, wherein the UE starts or restarts the timer in response to obtaining or updating the first TA.

17. The UE of claim 14, wherein the serving cell change is performed in response to a reconfiguration with sync or a L1/L2 Triggered Mobility (LTM) procedure.

18. The UE of claim 14, wherein the UE stores a third TA associated with a source cell when initiating an LTM procedure to a second candidate cell.

19. The UE of claim 14, wherein the UE clears or discards the first TA based on an Identity (ID) associated with the first TA, an ID associated with the first candidate cell, or a remaining valid time of the first TA.

20. The UE of claim 14, wherein the UE clears or discards the first TA based on: an ID associated with the first TA is lowest among IDs of stored and/or valid TAs associated with the at least one candidate cell, an ID associated with the first candidate cell is lowest among IDs of the at least one candidate cell with stored and/or valid TAs, a remaining valid time of the first TA is shortest among the at least one candidate cell with stored and/or valid TA, the first TA is a very first TA stored in the list or the set of stored TAs, or the first TA is invalid.
